(19) United States
(12) Patent Application Publication
(10) Pub. No.: US 2021/0224900 A1
(43) Pub. Date: Jul. 22, 2021

(54) STRESS TESTING AND ENTITY PLANNING MODEL EXECUTION APPARATUS, METHOD, AND COMPUTER READABLE MEDIA

(71) Applicant: Deutsche AG, Frankfurt am Main (DE)

(72) Inventors: KRESIMIR MARUSIC, Jersey City, NJ (US); Arvind Kumar Rai, Harrison, NJ (US); Bharat Gopalan, New York, NY (US); Young Been Eom, River Vale, NJ (US); Dwight Silvera, Newburgh, NY (US); Brandon Von-Feldt, New York, NY (US); Monojit Mitra, Stamford, CT (US); Laura Bertarelli, New York, NY (US); Rajneesh Acharya, Princeton Junction, NJ (US); Seth Lipschitz, Tenafly, NJ (US); Jason Lin, Syosset, NY (US); Patricia M. Gavin, Brooklyn, NY (US); Ronakkumar S. Patel, Edison, NJ (US)

(21) Appl. No.: 17/221,268

(22) Filed: Apr. 2, 2021

Related U.S. Application Data
(63) Continuation-in-part of application No. 16/272,119, filed on Feb. 11, 2019.
(60) Provisional application No. 62/628,399, filed on Feb. 9, 2018.

(51) Int. Cl. G06Q 40/02; G06N 20/00

(52) U.S. Cl. CPC G06Q 40/025; G06N 20/00

(57) ABSTRACT

A method and product designed for preferably creating, validating and executing regression based models and calculations for Stress Testing and Entity Planning purposes is provided covering model execution life-cycle details from model creation, validation, and execution. The preferred embodiments include a self-service regression based model configuration and creation with workflow approval tool called a model wizard; a central standardized I/O data interface called ODS to receive and store quarterly historical and spot financial market information, and reference data used as model input, and to store model output(s) in the preferred form of quarterly base and stress projections; a java based execution engine to run the approved models from the repository with ability to apply model adjustments; a web-based user interface to view the model lineage, input, equations in mathematical form using MathJax and the output.

### CROSS-REFERENCE TO RELATED APPLICATIONS

This application is a continuation in part of U.S. patent application Ser. No. 16/272,119, filed Feb. 11, 2019, which claims priority to U.S., Provisional patent Application No. 62/628,399, filed Feb. 9, 2018, the entire contents of which are incorporated herein by reference.

### FIELD OF THE INVENTION

The present invention relates to the field of Dodd-Frank Act Stress Testing for banks and other financial institutions.

### BACKGROUND OF THE INVENTION

The Federal Reserve Bank (FRB) annual stress test (the Dodd-Frank Act Stress Testing (DFAST)); and the associated annual capital planning review (Comprehensive Capital Analysis and Review (CCAR), began in 2009 and have created an industry-wide requirement to source, systemize, project, aggregate, and report data on a scale that no bank has ever done before.

US Banks (and then also foreign banks in the scope of this exercise) initially started with a spreadsheet-based approach to addressing the new FRB requirements. Processing speed for this approach, both computational as well as analytical, were long and costly. A search for sustainable computerized solutions to facilitate stress-testing work has therefore been going on since the inception of the stress test.

The Assignee, Deutsche Bank (DB) joined stress testing in 2013 as a DFAST filer. Initially, the effort was all spreadsheet-based. Since then, DB has deployed computerized, internal-cloud based solutions. DB is continuing development of the computer and hardware aspects of the solutions, described herein as Operational Data Store (ODS; for data), and Model Execution Environment (Me2; for projections).

DFAST requires banking organizations with average total assets of $10bn plus to conduct stress tests.

CCAR is/are a set of requirements used by the regulators to oversee bank holding companies (BHCs) with average total assets of $50bn. CCAR requirements address capital adequacy, capital distribution, and capital planning processes under base and stress economic scenarios.

In addition to the above, in February 2014, the FRB approved the final rule establishing Enhanced Prudential Standards (EPS) for large Foreign Banking Organizations (FBOs) which required the largest FBOs to consolidate all US legal entity ownership interests under a single, top-tier Intermediate Holding Company (IHC). Once formed, the IHC will then be subject to EPS similar to those of BHCs, including capital, liquidity and risk management requirements.

The assignee, Deutsche Bank, setup the IHC “DB USA Corp Inc.” on Jul. 1, 2016.

The Stress Testing and Entity Planning (STEP) platform was introduced to enable more automated, controlled, efficient, and accurate financial planning and capital management across products, divisions, and scenarios for its US operations for entities DB USA Corp Inc. (IHC) and its affiliates Deutsche Bank Trust Company (DBTC) and Deutsche Bank Trust Company Americas (DBTCA).

Prior to the STEP platform being built, all CCAR/DFAST Stress Testing models were configured and executed in Microsoft Excel macro based worksheets with significant data, version and access control issues. Business and Entity forecasting and risk models which included balance sheet, wholesale credit losses, net income interest (NII), non-interest revenue (NIR) and non-interest expense (NIE), Tax and Capital Risk Weighted Average (RWA) models were configured and executed manually in excel spreadsheets. The data required to execute the above mentioned models was collected manually from various internal and external data sources and manually copy-pasted into the model excel worksheets, output generated and then manually uploaded into an excel macro based tool called Line of Business (LOB) Projections platform (LOB PP) for FR (Federal Register) Y-14A aggregation and reporting. Moreover, the old process did not have enough controls and mechanism to capture and store distinct model adjustments such as strategic actions and idiosyncratic events, which are very important for performing attribution analyses for capital ratios. The whole process of sequentially collecting, executing, and aggregating CCAR/DFAST projections in FED allowable format in LOB PP took over 90 calendar days with significant process, review and control challenges leaving very little time for the individual businesses for their review and challenge process and for senior management for applying any management overlays to the entity level projections. Hence, there is a need for an automated, controlled, efficient, and accurate financial planning and capital management software platform that supported Intermediate Holding Company (IHC) Stress Testing across products, entities, divisions, and scenarios.

### SUMMARY OF THE INVENTION

The technology underpinning the Stress Testing and Entity Planning process is a component-based architecture which enables firms to: Leverage existing processes and solutions where needed, adapt as new strategic systems or market solutions emerge, and allow for more granular contingency plans.

The Stress Testing Operational Data Store (ODS) embodiments preferably provide a centralized Stress Testing view of the data required for capital planning, including: historical, spot, and projected financial data, along with market and business data; support of the regulatory data archiving requirements; and standardized Input/Output (I/O) data interface(s).

The Model Execution Environment (Me2) embodiments provide a controlled, robust, strategic, and sustainable platform designed to automate and execute models and calculations for Stress Testing and Financial Planning purposes. This execution environment is designed to create, execute, adjust, and manage calculations and equations. The platform includes: a self-service model creation tool called Model Wizard; a fast Execution Engine to run Bank Pre-Provision Net Revenue (B/PPNR), Credit, Tax, and Credit Risk-Weighted Asset (RWA) within minutes (e.g., less than 10 minutes, preferably less than 5 minutes, more preferably less than 3 minutes, more preferably less than 2 minutes, more preferably less than 1 minute), thus allowing management to view Entity-level Capital Ratios on-demand/anytime; Interfaces to firm's pricing/risk model libraries; Robust model output adjustment framework;

Data attestation and approval workflow; Sensitivity Analysis; Supports integration with firm's financial reporting and aggregation systems (for example, SAP software).

According to a first aspect of the present invention, apparatus for conducting Dodd-Frank Act stress testing of a financial institution preferably includes (A) a user interface having a user display, a user input device, and at least one user processor; (B) at least one stress-test server coupled to the user interface and to least one external data source, the at least one stress-test server having at least one server processor coupled to at least one internal database; (C) the at least one server processor executing computer program code which provides a model wizard, a model execution engine, and a sensitivity analysis tool; (D) the model wizard receiving user inputs from the user interface, the user inputs including: (i) input financial information comprising historical financial data, spot financial data, projected financial data, market financial data, and time data; (ii) risk information, and (iii) model equation information; (E) the model execution engine using the user inputs, data from the external data source, and data from the internal database, to execute at least one equation to calculate (i) bank pre-provision net revenue information, (ii) credit information, (iii) tax information, (iv) credit risk-weighted asset information, and (v) capital ratios; (F) the model execution engine providing the calculated information to the user interface in at least one screenshot on the user display, the displayed information including (i) the calculated bank pre-provision net revenue information, (ii) the calculated credit information, (iii) the calculated tax information, (iv) the calculated credit risk-weighted asset information, and (v) the calculated capital ratios; (G) the model wizard receiving updated user inputs from the user interface, the updated user inputs including at least one of: (i) updated input financial information comprising at least one of updated historical financial data, updated spot financial data, updated projected financial data, updated market financial data, and updated time data; (ii) updated risk information, and (iii) updated model equation information; (H) the model execution engine using the updated user inputs, data from the external data source, and data from the internal database, to execute at least one equation to calculate at least one of (i) updated bank pre-provision net revenue information, (ii) updated credit information, (iii) updated tax information, (iv) updated credit risk-weighted asset information, and (v) updated capital ratios; (I) the model execution engine providing the updated calculated information to the user interface in at least one screenshot on the user display, the displayed information including at least one of (i) the calculated updated bank pre-provision net revenue information, (ii) the calculated updated credit information, (iii) the calculated updated tax information, (iv) the calculated updated credit risk-weighted asset information, and (v) the calculated updated capital ratios; (J) the model execution engine executing the sensitivity analysis tool to (i) provide to the user interface display at least one screenshot for input of at least one custom stress test macro-economic driver-based scenario using at least one mathematical model stored in the internal database, and (ii) run the at least one scenario to determine model sensitivity and impact on the calculated updated capital ratios. Preferably, the at least one stress-test server causes the updated calculated information to be supplied to the user display within 5 minutes of receiving the updated user inputs. Preferably, the at least one stress-test server causes the updated calculated information to be supplied to the user display within 3 minutes of receiving the updated user inputs. Preferably, the at least one stress-test server causes the updated calculated information to be supplied to the user display within 1 minute of receiving the updated user inputs. Preferably, n the model wizard includes a create/edit model module, a validate module, a submit model module, and an approve model module. Preferably, the model execution engine includes a model repository module, a model input module, an execution module, a model output module, and a view and adjust model module. Preferably, the create/edit model module includes a check user entitlement module, a forecaster module, an add/edit model metadata module, an add/edit model input attributes module, an add/edit risk attributes module, an add/edit model equation module, and a save draft module. Preferably, the validate module and the submit model module include an open draft model module, an add model input data module, a validate model module, an expected output module, and a submit for approval module. Preferably, the at least one server processor further executes core services comprising at least one equation application programming interface and at least one caching service. Preferably, the at least one server processor integrates with SAP software.

According to a second aspect of the present invention, a computer implemented method of for conducting Dodd-Frank Act stress testing of a financial institution preferably includes (A) providing a user interface having a user display, a user input device, and at least one user processor; (B) providing at least one stress-test server coupled to the user interface and to least one external data source, the at least one stress-test server having at least one server processor coupled to at least one internal database; (C) the at least one server processor executing computer program code which provides a model wizard, a model execution engine, and a sensitivity analysis tool; (D) the model wizard receiving user inputs from the user interface, the user inputs including: (i) input financial information comprising historical financial data, spot financial data, projected financial data, market financial data, and time data; (ii) risk information, and (iii) model equation information; (E) the model execution engine using the user inputs, data from the external data source, and data from the internal database, to execute at least one equation to calculate (i) bank pre-provision net revenue information, (ii) credit information, (iii) tax information, (iv) credit risk-weighted asset information, and (v) capital ratios; (F) the model execution engine providing the calculated information to the user interface in at least one screenshot on the user display, the displayed information including (i) the calculated bank pre-provision net revenue information, (ii) the calculated credit information, (iii) the calculated tax information, (iv) the calculated credit risk-weighted asset information, and (v) the calculated capital ratios; (G) the model wizard receiving updated user inputs from the user interface, the updated user inputs including at least one of: (i) updated input financial information comprising at least one of updated historical financial data, updated spot financial data, updated projected financial data, updated market financial data, and updated time data; (ii) updated risk information, and (iii) updated model equation information; (H) the model execution engine using the updated user inputs, data from the external data source, and data from the internal database, to execute at least one equation to calculate at least one of (i) updated bank pre-provision net revenue information, (ii) updated credit information, (iii) updated tax information, (iv) updated credit risk-weighted asset information, and (v) updated capital ratios; (I) the model execution engine providing the updated calculated information to the user interface in at least one screenshot on the user display, the displayed information including at least one of (i) the calculated updated bank pre-provision net revenue information, (ii) the calculated updated credit information, (iii) the calculated updated tax information, (iv) the calculated updated credit risk-weighted asset information, and (v) the calculated updated capital ratios; (J) the model execution engine executing the sensitivity analysis tool to (i) provide to the user interface display at least one screenshot for input of at least one custom stress test macro-economic driver-based scenario using at least one mathematical model stored in the internal database, and (ii) run the at least one scenario to determine model sensitivity and impact on the calculated updated capital ratios.

According to a third aspect of the present invention, at least one non-transitory computer-readable media preferably includes computer program code to cause at least one processor to conduct Dodd-Frank Act stress testing of a financial institution using (A) a user interface having a user display, a user input device, and at least one user processor, and (B) at least one stress-test server coupled to the user interface and to least one external data source, the at least one stress-test server having at least one server processor coupled to at least one internal database; (C) the at least one server processor executing computer program code which provides a model wizard, a model execution engine, and a sensitivity analysis tool; (D) the model wizard receiving user inputs from the user interface, the user inputs including: (i) input financial information comprising historical financial data, spot financial data, projected financial data, market financial data, and time data; (ii) risk information, and (iii) model equation information; (E) the model execution engine using the user inputs, data from the external data source, and data from the internal database, to execute at least one equation to calculate (i) bank pre-provision net revenue information, (ii) credit information, (iii) tax information, (iv) credit risk-weighted asset information, and (v) capital ratios; (F) the model execution engine providing the calculated information to the user interface in at least one screenshot on the user display, the displayed information including (i) the calculated bank pre-provision net revenue information, (ii) the calculated credit information, (iii) the calculated tax information, (iv) the calculated credit risk-weighted asset information, and (v) the calculated capital ratios; (G) the model wizard receiving updated user inputs from the user interface, the updated user inputs including at least one of: (i) updated input financial information comprising at least one of updated historical financial data, updated spot financial data, updated projected financial data, updated market financial data, and updated time data; (ii) updated risk information, and (iii) updated model equation information; (H) the model execution engine using the updated user inputs, data from the external data source, and data from the internal database, to execute at least one equation to calculate at least one of (i) updated bank pre-provision net revenue information, (ii) updated credit information, (iii) updated tax information, (iv) updated credit risk-weighted asset information, and (v) updated capital ratios; (I) the model execution engine providing the updated calculated information to the user interface in at least one screenshot on the user display, the displayed information including at least one of (i) the calculated updated bank pre-provision net revenue information, (ii) the calculated updated credit information, (iii) the calculated updated tax information, (iv) the calculated updated credit risk-weighted asset information, and (v) the calculated updated capital ratios; (J) the model execution engine executing the sensitivity analysis tool to (i) provide to the user interface display at least one screenshot for input of at least one custom stress test macro-economic driver-based scenario using at least one mathematical model stored in the internal database, and (ii) run the at least one scenario to determine model sensitivity and impact on the calculated updated capital ratios.

### BRIEF DESCRIPTION OF THE DRAWINGS

FIG. 1 illustrates an example computer environment suitable for implementation of stress testing and entity planning model execution environment and methods within the embodiments of the present invention.

FIG. 2 illustrates an example flow diagram that provides a generalized illustration of model setup and validation processes using a model wizard and execution process using the model execution environment (Me2) according to embodiments of the present invention.

FIG. 3 illustrates a generalized flow diagram illustrating the model setup process according to embodiments of the present invention.

FIG. 4 illustrates a generalized flow diagram illustrating the model validation process according to embodiments of the present invention.

FIG. 5 illustrates, in block diagram form, an architectural overview of an example computer system upon which embodiments of the present disclosure may be implemented.

FIG. 6 illustrates, in block diagram form, an example computer system with component architecture for an execution engine upon which embodiments of the present invention may be implemented.

FIG. 7 illustrates in block diagram form an alternate architecture overview of an example computer system using micro-services upon which an embodiment of the present invention may be implemented.

FIG. 8 illustrates the generalized flow diagram for sensitivity analysis and attribution process for Stress Testing according to the embodiment of the present technology.

FIG. 9 illustrates the generalized flow diagram for parallel processing of Stress Testing models according to the embodiment of the present technology.

FIGS. 10a through 10z, and 10aa through 10ac, are computer display screen shots showing processes according to embodiments of the present invention.

FIG. 11 is a functional block diagram showing the system architecture according to a further embodiment.

FIG. 12 is a functional process diagram showing the system operations according to the further embodiment.

FIG. 13 is a screen shot showing system advantages according to the further embodiment.

FIG. 14 is a screen shot showing timing advantages according to the further embodiment.

FIG. 15 is another screen shot showing timing advantages according to the further embodiment.

FIG. 16 is a screen shot showing timing advantages according to the further embodiment.

FIG. 17 is a screen shot showing timing advantages according to the further embodiment.

FIG. 18 is a screen shot showing timing advantages according to the further embodiment.

FIG. 19 is a screen shot showing timing advantages according to the further embodiment.

### DETAILED DESCRIPTION

The following description of example methods and systems is not intended to limit the scope of the description to the precise form or forms detailed herein. Instead, the following description is intended to be illustrative so that others may follow its teachings.

In the following description, for the purposes of explanation, numerous specific details are set forth in order to provide a thorough understanding of the present description. It will be apparent, however, that the present description may be practiced without these specific details. In other instances, well known structures and devices are shown in block diagram form in order to avoid unnecessarily obscuring the present description.

All features described here should be used together, although the implementation may not have to necessarily match the embodiments in this document.

Implementation of the process is preferably on at least one computer platform preferably having Unix/Linux operating system with a processor core that can preferably do all the basic operations described herein. This system now can compute stress testing model calculation operations in parallel and operate at a modest clock rate of 50 KHz for Credit RWA calculations (For Credit RWA models, assuming 300000 transactions, 5 stress scenarios and Q0-Q9 (10 quarterly) calculations, the process takes 5 mins (5*60 seconds) or in other words, the system performs 300000*5*10/5*60=50000 calculations per second (˜50 KHz)). The processing functions (in the computerized platform), processors, and the remote participant processors) can be performed by any of the above and any suitable combination of Personal Computers, servers, cloud-based devices, etc.

### Glossary

The words “computational device”, “computer”, and “device” are used interchangeably and can be construed to mean the same thing.

A “device” in this specification may include, but is not limited to, one or more of, or any combination of processing device(s) such as, a cell phone, a Personal Digital Assistant, a smart watch or other body-borne device (e.g., glasses, pendants, rings, etc.), a personal computer, a laptop, a pad, a cloud-access device, a white board, and/or any device capable of sending/receiving messages to/from a local area network or a wide area network (e.g., the Internet).

A “driver” in this specification may include, but is not limited to, one or more of, or any combination of device and/or processor driver(s). A driver is a computer program that operates or controls a particular type of device that may be attached to a computer. A driver provides a software interface to hardware devices, enabling operating systems and other computer programs to access hardware functions without needing to know precise details of the hardware being used.

An “engine” is preferably a program that performs a core function for other programs. An engine can be a central or focal program in an operating system, subsystem, or application program that coordinates the overall operation of other programs. It is also used to describe a special-purpose program containing an algorithm that can sometimes be changed. The best known usage is the term search engine which uses an algorithm to search an index of topics given a search argument. An engine is preferably designed so that its approach to searching an index, for example, can be changed to reflect new rules for finding and prioritizing matches in the index. In artificial intelligence, for another example, the program that uses rules of logic to derive output from a knowledge base is called an inference engine. A “module” may comprise one or more engines and/or one or more hardware modules, or any suitable combination of both.

As used herein, a “server” may comprise one or more processors, one or more Random Access Memories (RAM), one or more Read Only Memories (ROM), one or more user interfaces, such as display(s), keyboard(s), mouse/mice, etc. A server is preferably apparatus that provides functionality for other computer programs or devices, called “clients.” This architecture is called the client-server model, and a single overall computation is typically distributed across multiple processes or devices. Servers can provide various functionalities, often called “services”, such as sharing data or resources among multiple clients, or performing computation for a client. A single server can serve multiple clients, and a single client can use multiple servers. A client process may run on the same device or may connect over a network to a server on a different device. Typical servers are database servers, file servers, mail servers, print servers, web servers, game servers, application servers, and chat servers. The servers discussed in this specification may include one or more of the above, sharing functionality as appropriate. Client-server systems are most frequently implemented by (and often identified with) the request-response model: a client sends a request to the server, which performs some action and sends a response back to the client, typically with a result or acknowledgement. Designating a computer as “server-class hardware” implies that it is specialized for running servers on it. This often implies that it is more powerful and reliable than standard personal computers, but alternatively, large computing clusters may be composed of many relatively simple, replaceable server components.

The servers and devices in this specification typically use the one or more processors to run one or more stored “computer programs” and/or non-transitory “computer-readable media” to cause the device and/or server(s) to perform the functions recited herein. The media may include Compact Discs, DVDs, ROM, RAM, solid-state memory, or any other storage device capable of storing the one or more computer programs.

System Overview of Exemplary Embodiments

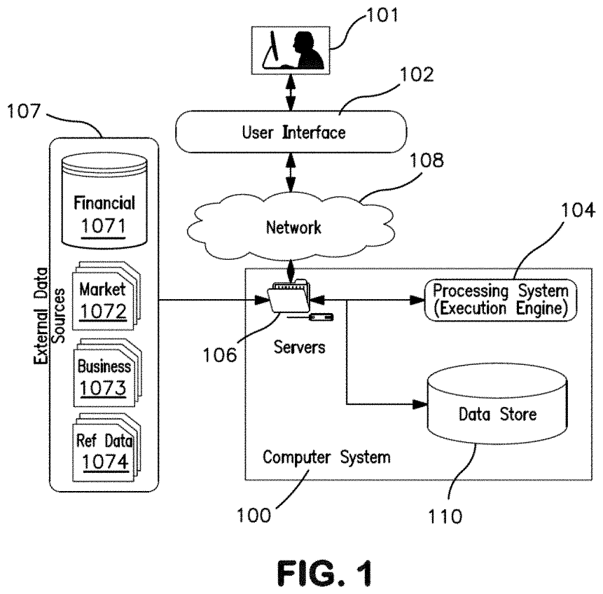

FIG. 1 illustrates an example computer networking environment for the implementation of at least one embodiment of the present disclosure. In one embodiment, the computer system 100 comprises a computing device configured over a cloud-based computing system or over a physical server.

In one embodiment, the computer system and/or device(s) preferably comprise(s) a computing device 100 providing a user 101 with an interface 102 to communicate through a network 108 (e.g., the Internet) to (i) one or more network file system (NFS) server(s) 106, (ii) one or more processing system (execution engine(s)) 104, and (iii) one or more relational database management system(s) (RDBMS) data store device(s) 110. This architecture allows users 101 to create, validate, and use regression-based models for stress testing purposes.

The computer system (and/or platform) 100 may be also be coupled and/or connected to one or more external data storage unit(s) 107 through network 108 and the NFS server(s) 106. The data storage unit(s) 107 may comprise one or more of financial data storage 171, market data storage 1072, business data storage 1073, and reference data storage 1074. In one embodiment, the network 108 represents any combination of one or more local and/or wide area networks.

Although only a particular number of elements are depicted in FIG. 1, a practical environment may have many more of each depicted element. For example, there may be more than one instance of processing system 104 executing on the computer system 100 simultaneously.

Overview of Model Execution Environment

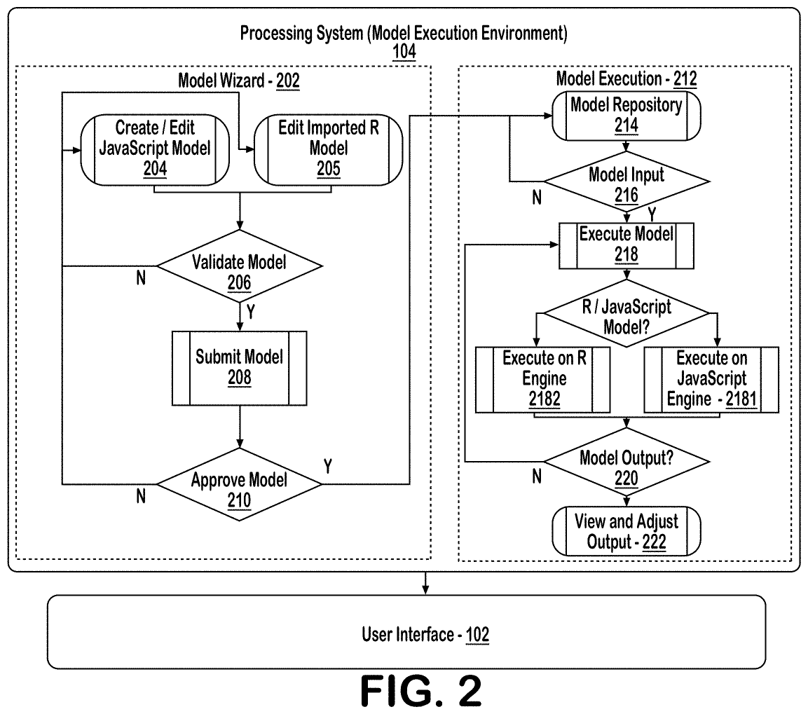

FIG. 2 illustrates a flow diagram of an exemplary embodiment of the model life cycle process covering a model wizard 202 and a model execution process 212. FIG. 2 provides a more detailed example of the processing carried out with the processing system 104.

In the exemplary embodiments, access to the model wizard 202 and the model execution 212 process is preferably managed via a 2-step authentication process. This involves authorization of user's firm level credentials such as network/windows login ID and then application level access which drives what screens user can view and what actions he or she can perform. Application level access can be password protected.

In an embodiment, the model execution environment processing system 104 includes model wizard 202 process steps such as create/edit model 204, edit imported R based model 205, validate model 206, submit model for approval 208, and approve model 210; model execution 212 process steps such as read model repository 214, verify model input 216, execute model 218, based on model equation syntax language it get executed on JavaScript Engine 2181 or R Engine 2182, generate and store model output 220, and view/apply adjustments 222.

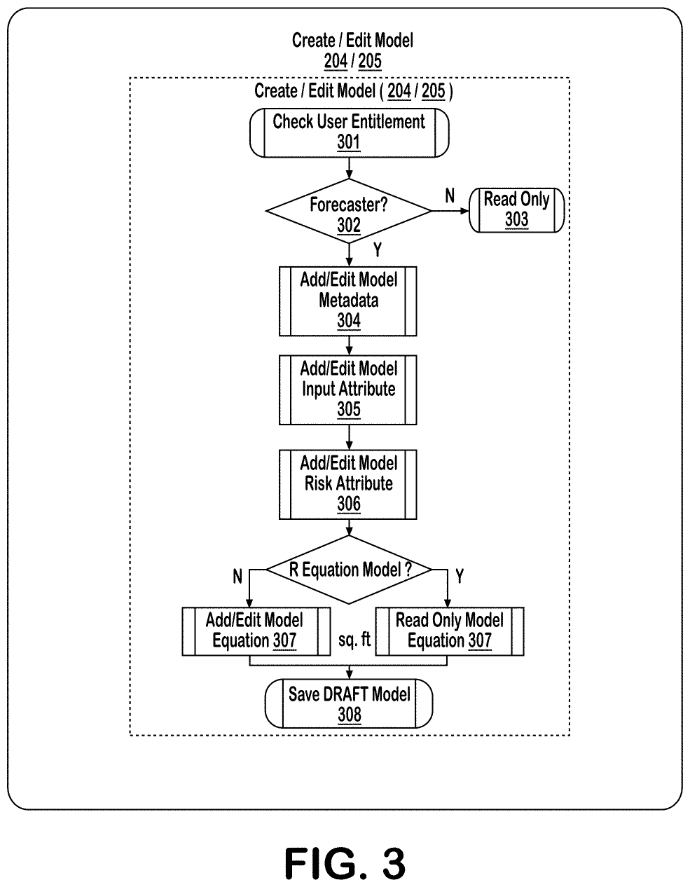

In a preferred embodiment, the processing system 104 supports specific driver-based linear and non-linear regression model types that can be configured via the model wizard 202 using the create/edit model 204 feature or edit imported R syntax model 205. The create/edit model step 204 and 205 will be described in greater detail below with respect to FIG. 3.

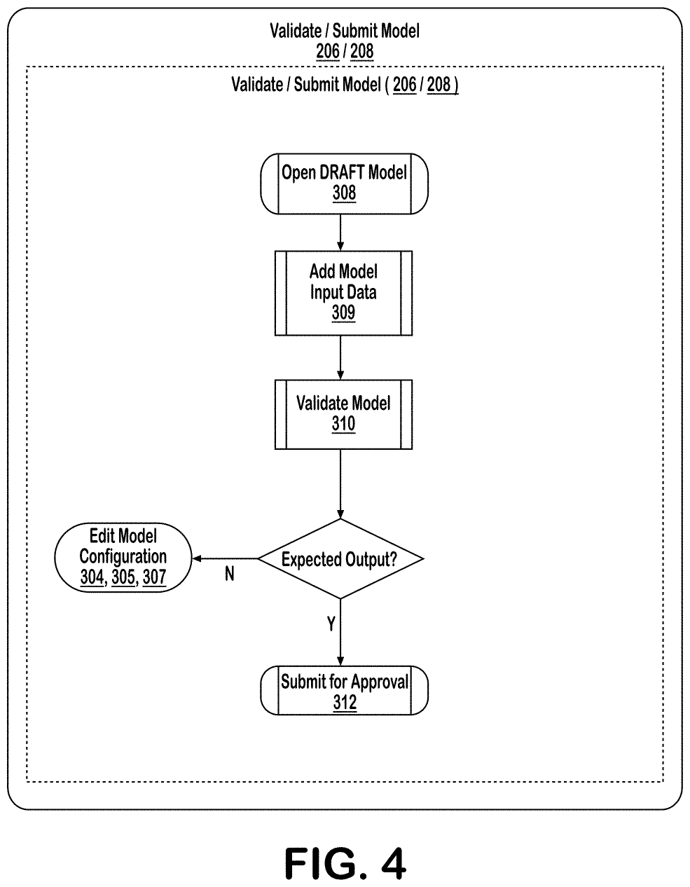

The validate model step 206 is a control process provided in the self-service model wizard 202, which step 206 provides for models to be validated before submitting the model at step 208 for approval. This step ensures models are stored in the validated and the results store and are submitted for approval before the models become part of the model repository 214. The validate model step 206, and the submit model step 208 will be described in greater detail below with respect to FIG. 4.

Once the model is validated in step 206, and submitted by a modeler/model forecaster in step 208, it is available in the model approver's queue as a task for approval/rejection. The model approver can view the model setup and model validation results to either approve the model in step 210 or reject the model, in which case the flow goes back to step 204 if model is JavaScript model and goes back to flow 205 if Model is R calculation based model and available in modeler/model forecaster's queue for further review and edit/update.

After approval, the model(s) become part of the ‘ACTIVE’ model repository in step 214 and is/are stored in the data store 210 (model data is preferably stored into multiple relational database tables/objects split by logical data-model) and available for execution as part of the IHC CCAR stress testing process, which is the first step in the execution engine process 212.

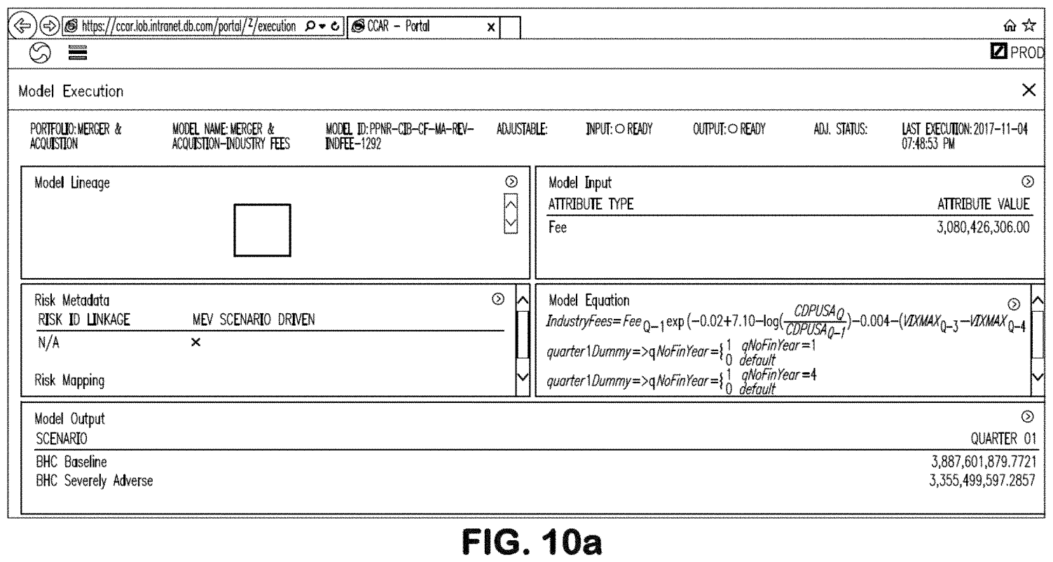

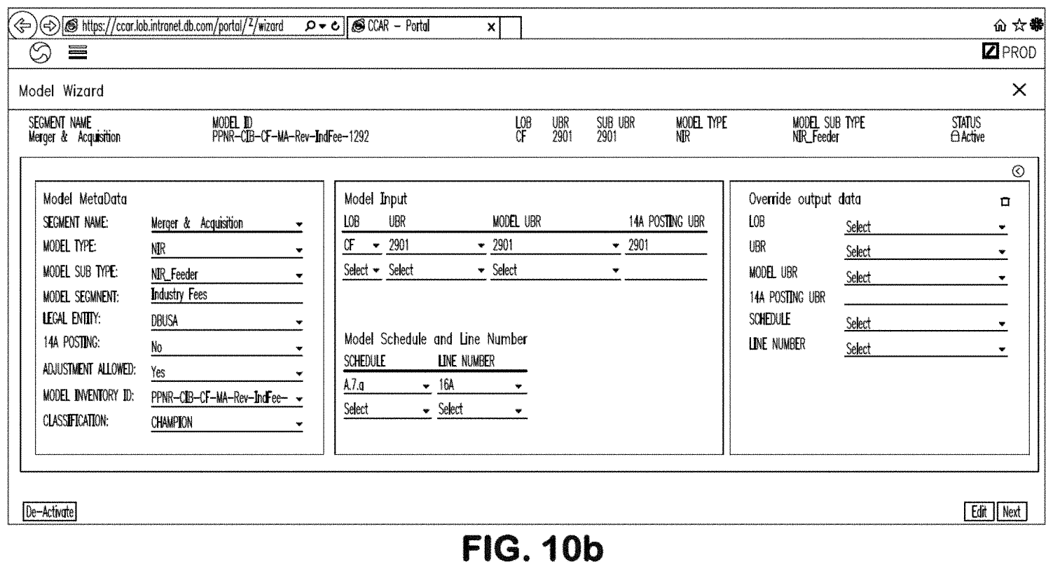

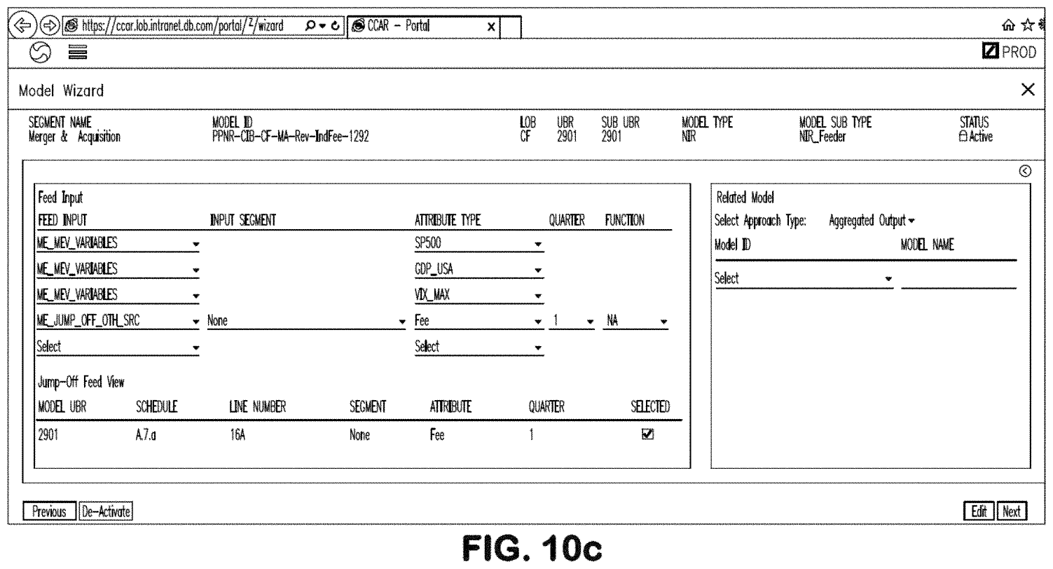

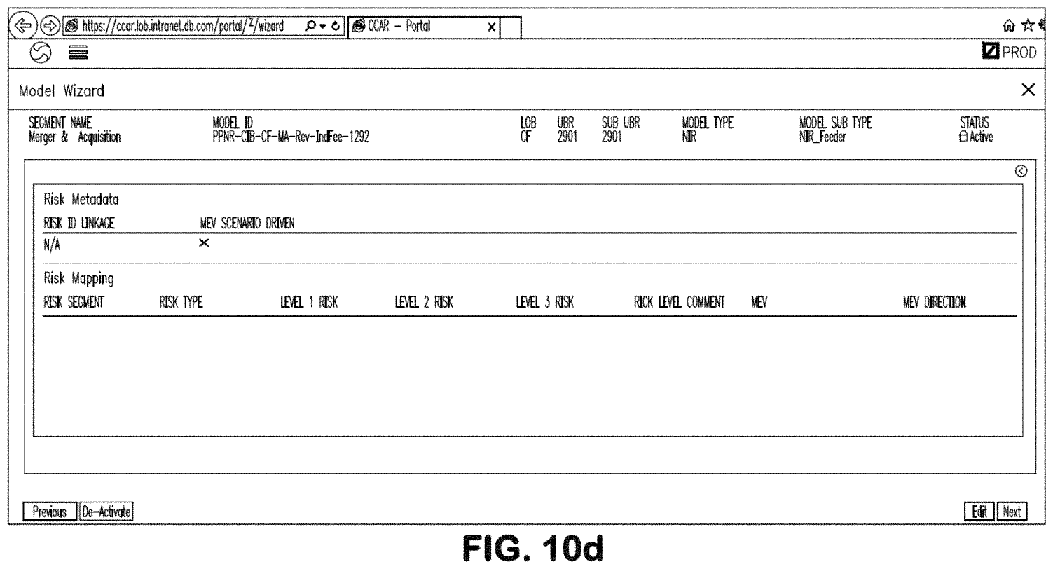

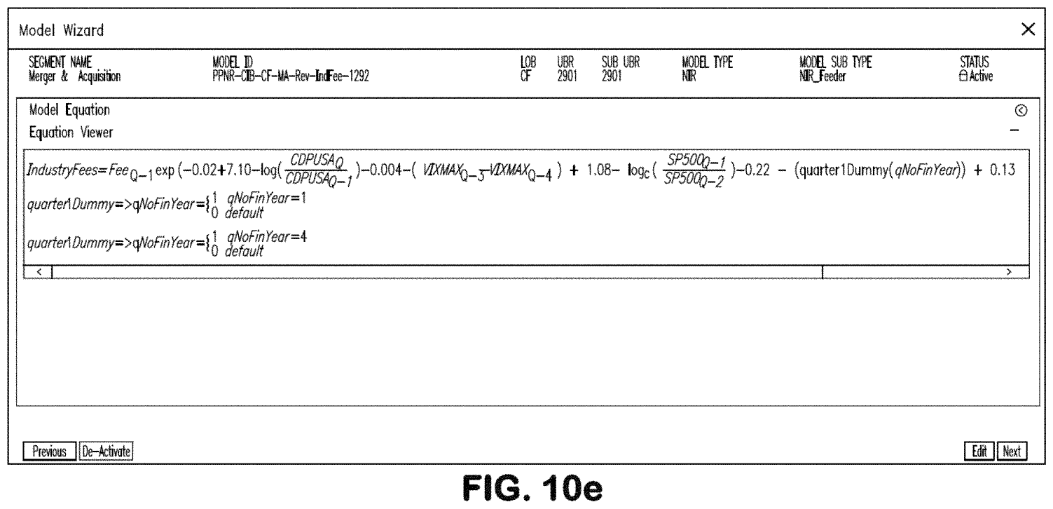

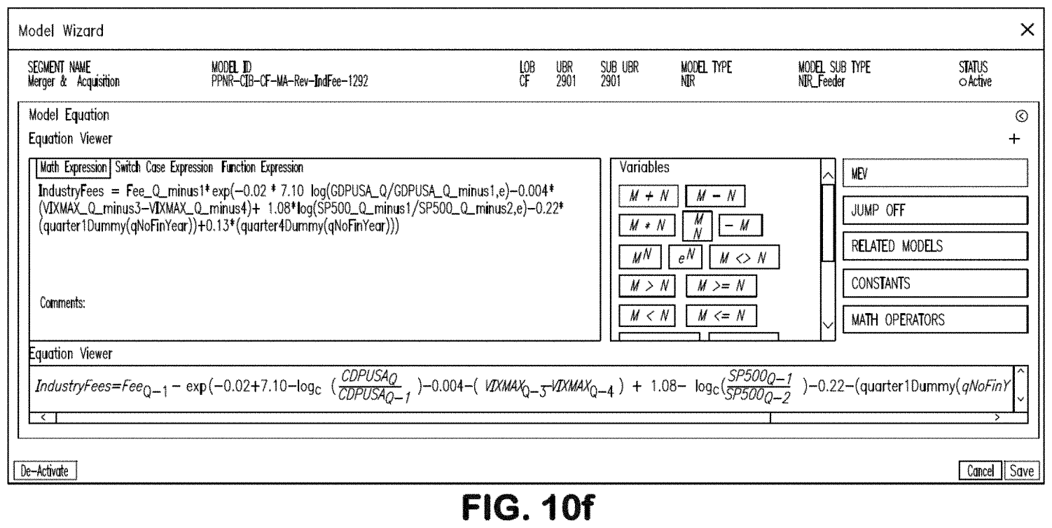

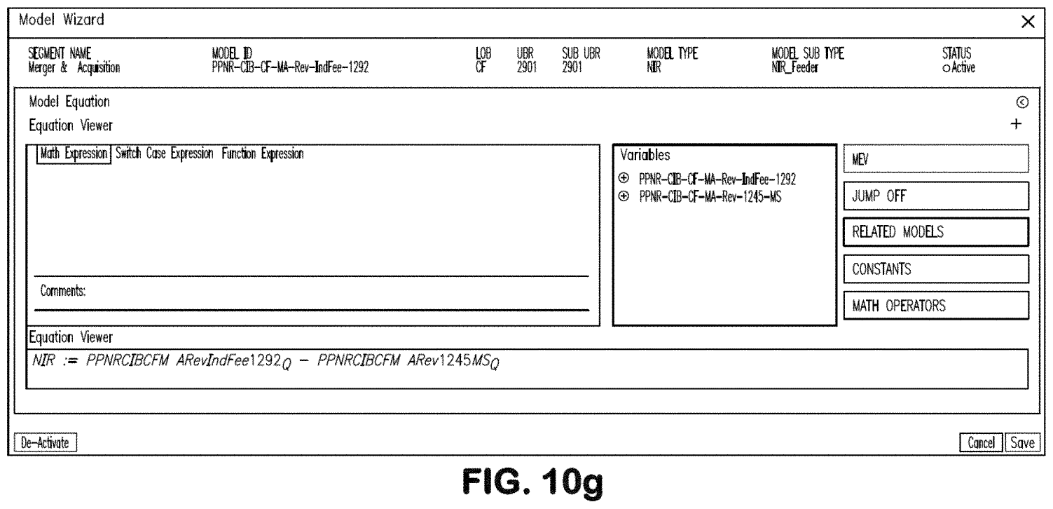

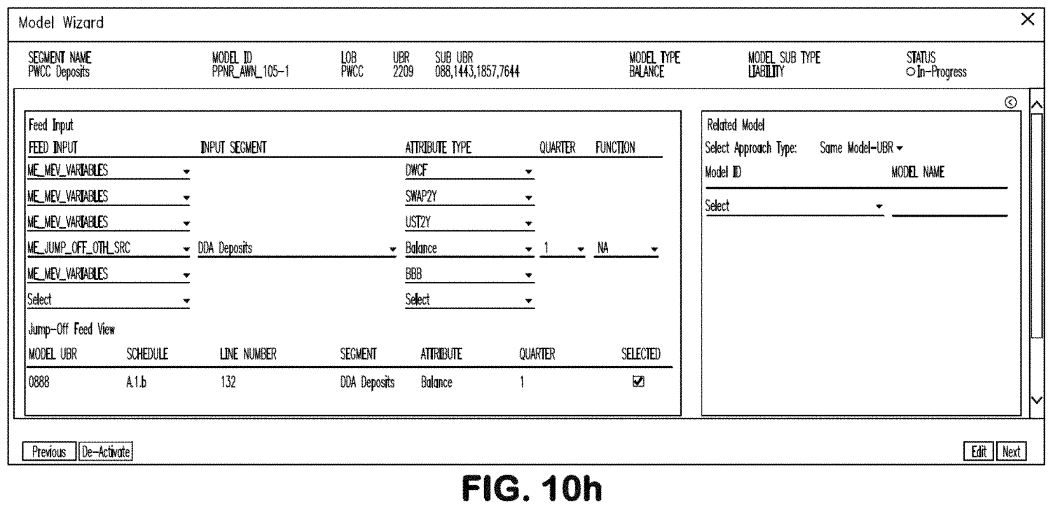

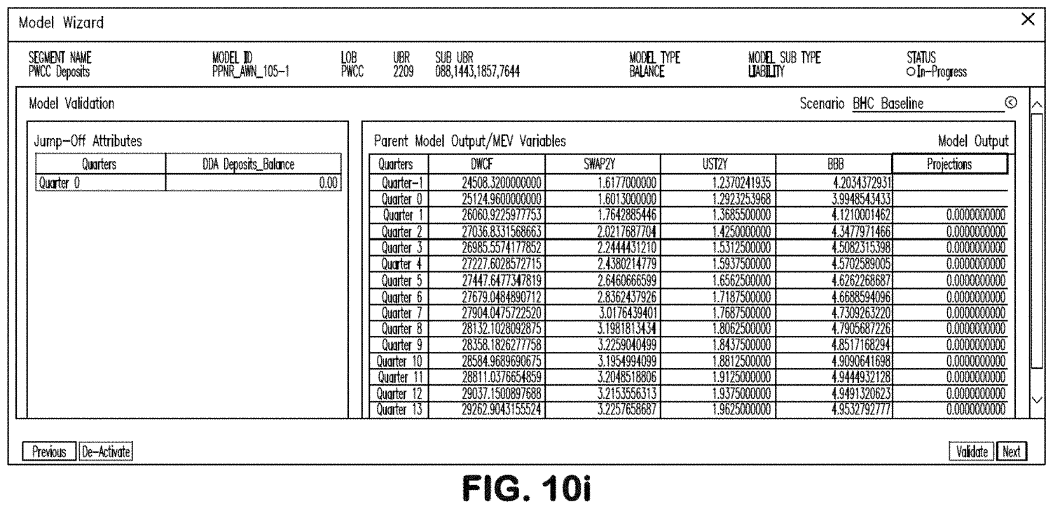

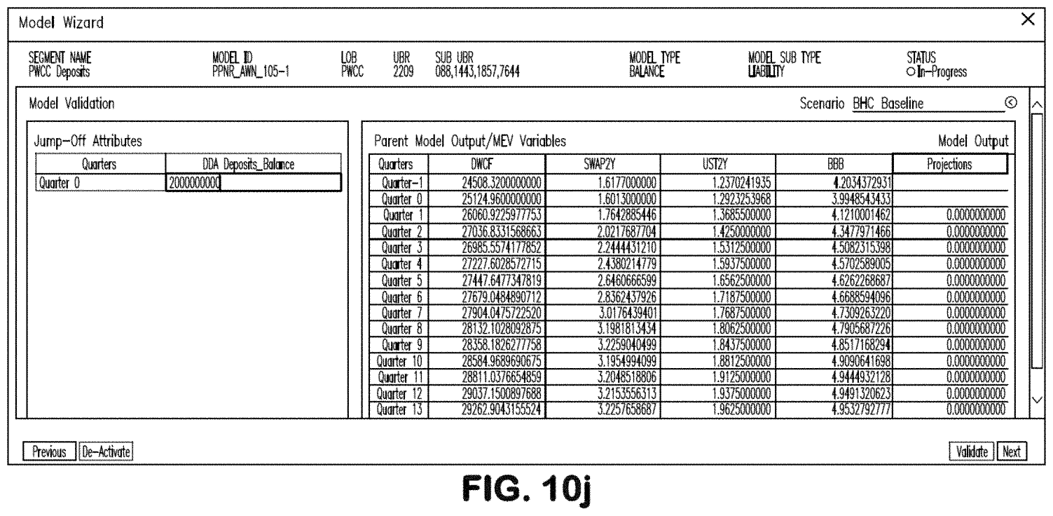

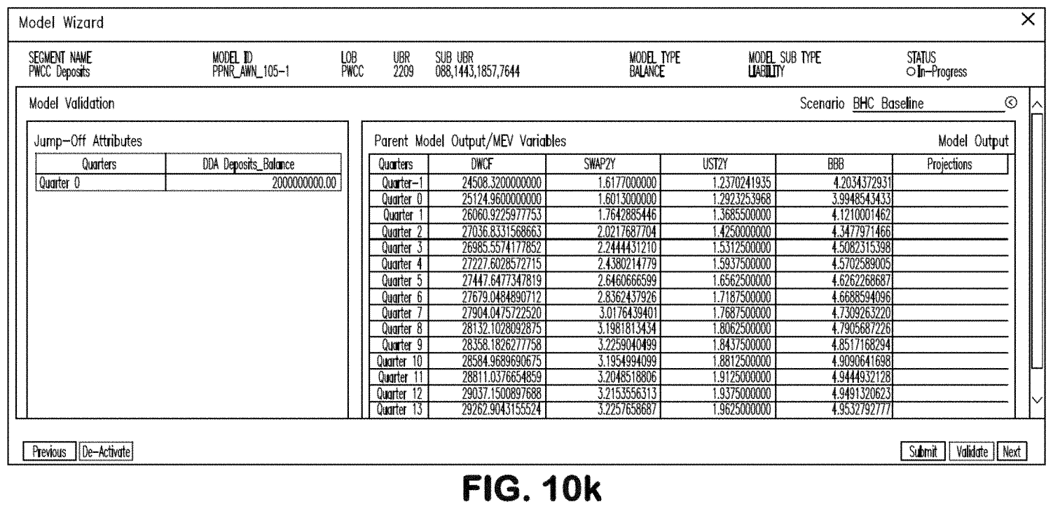

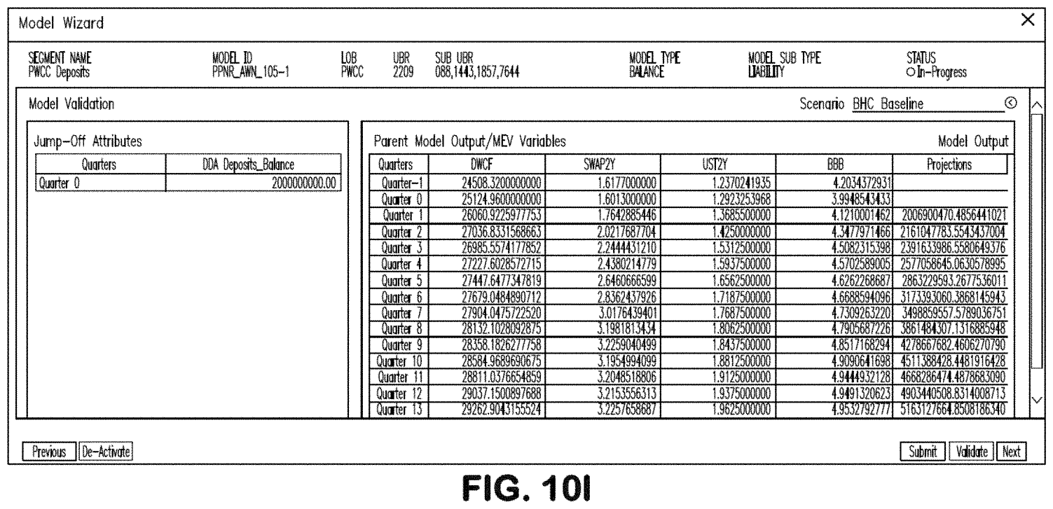

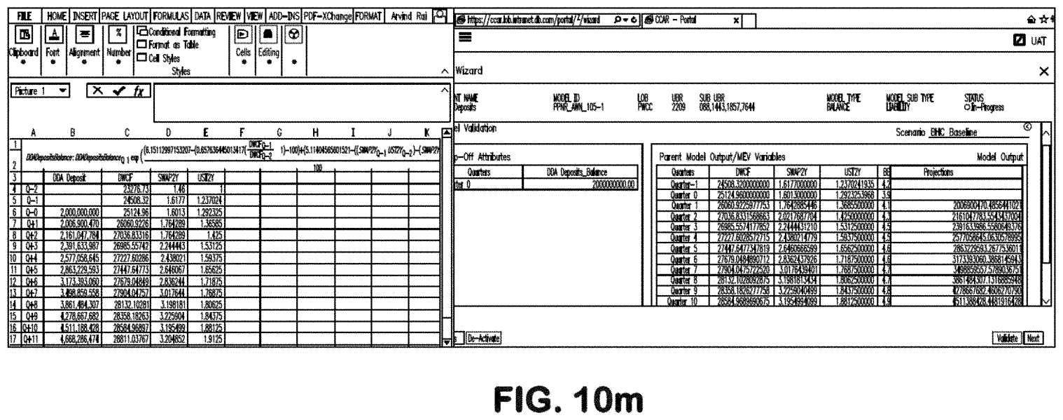

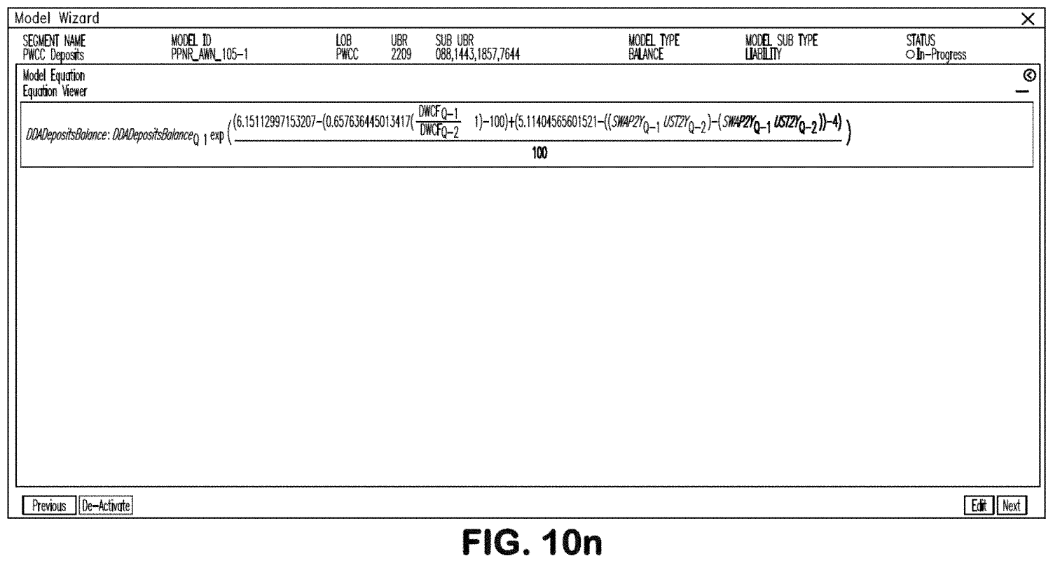

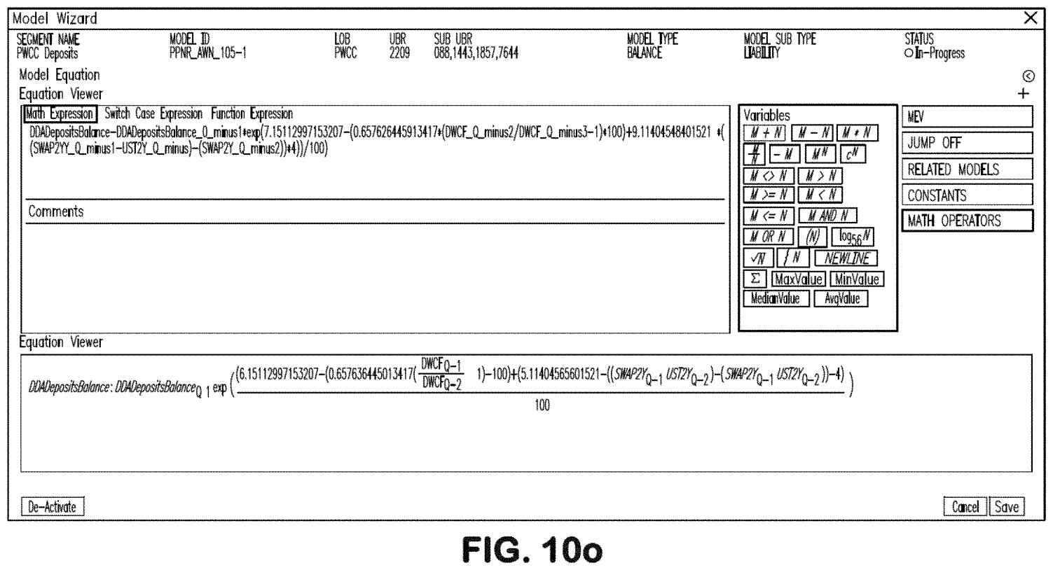

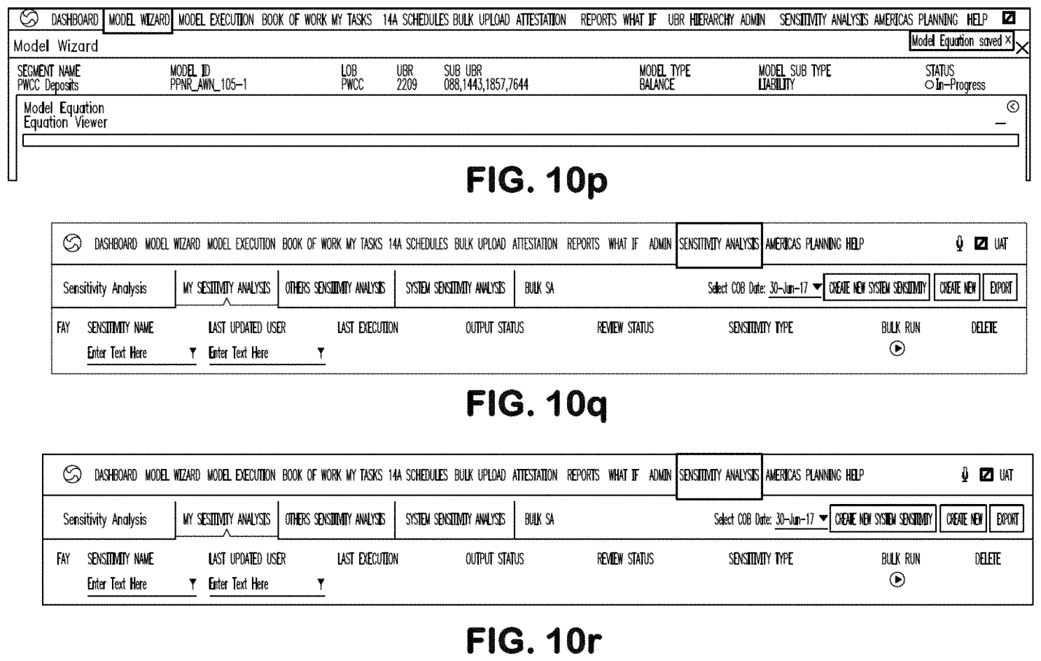

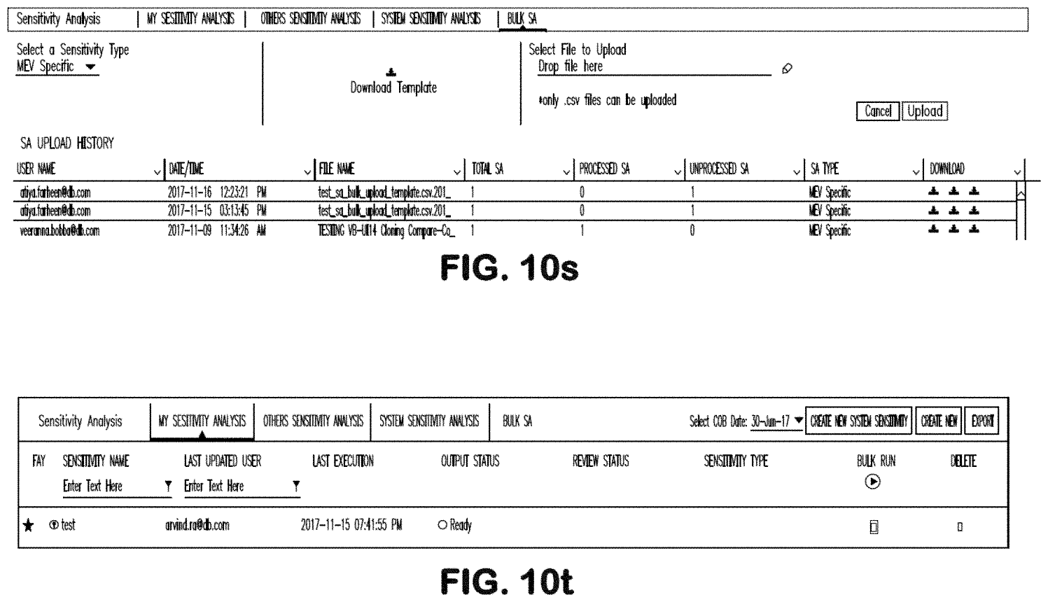

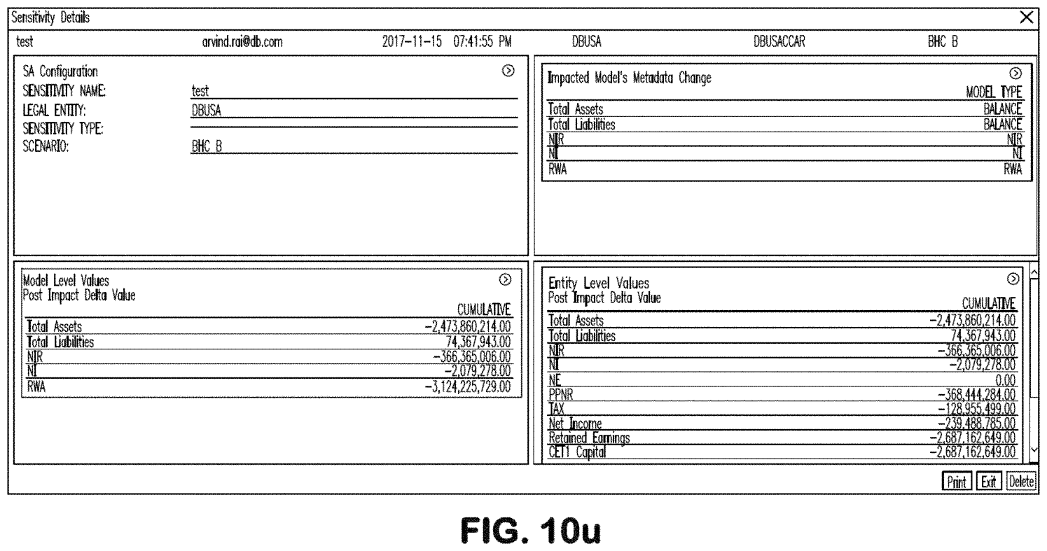

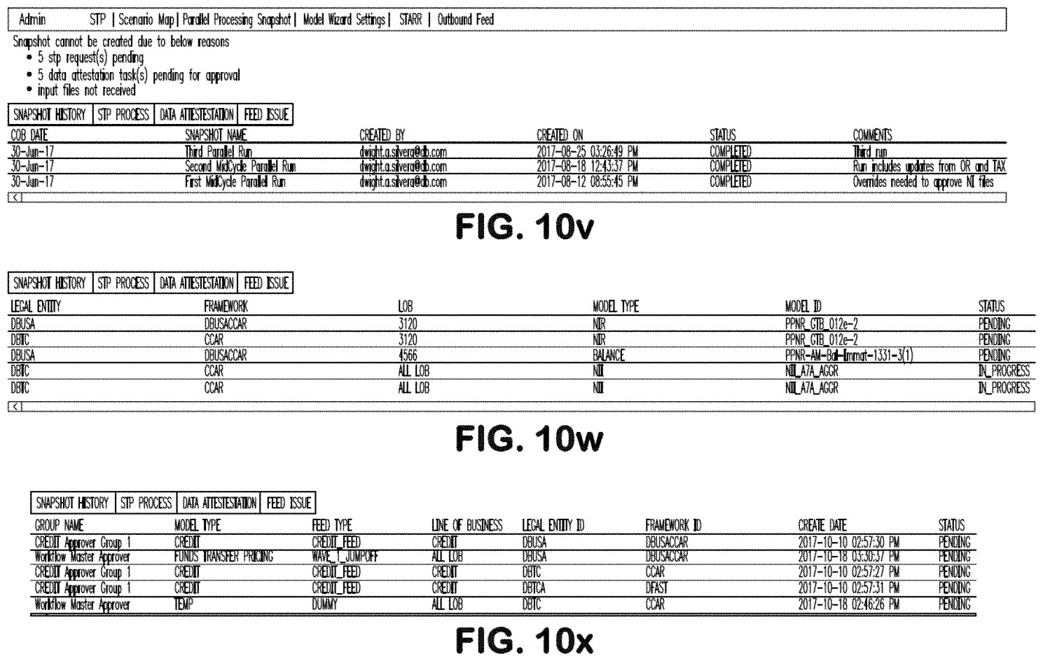

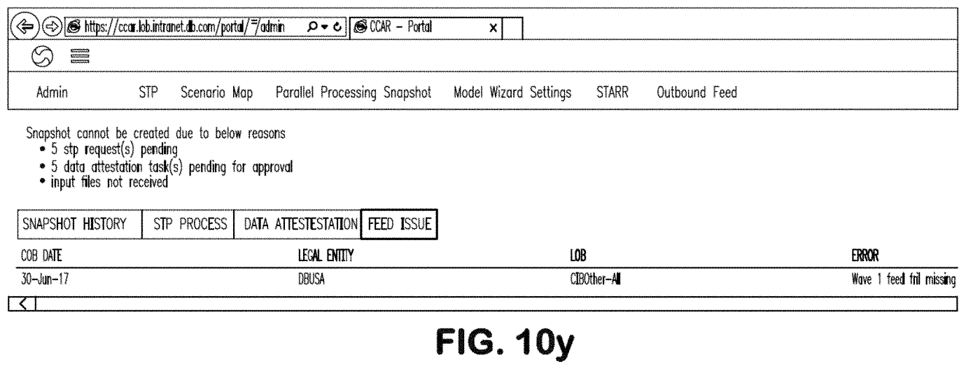

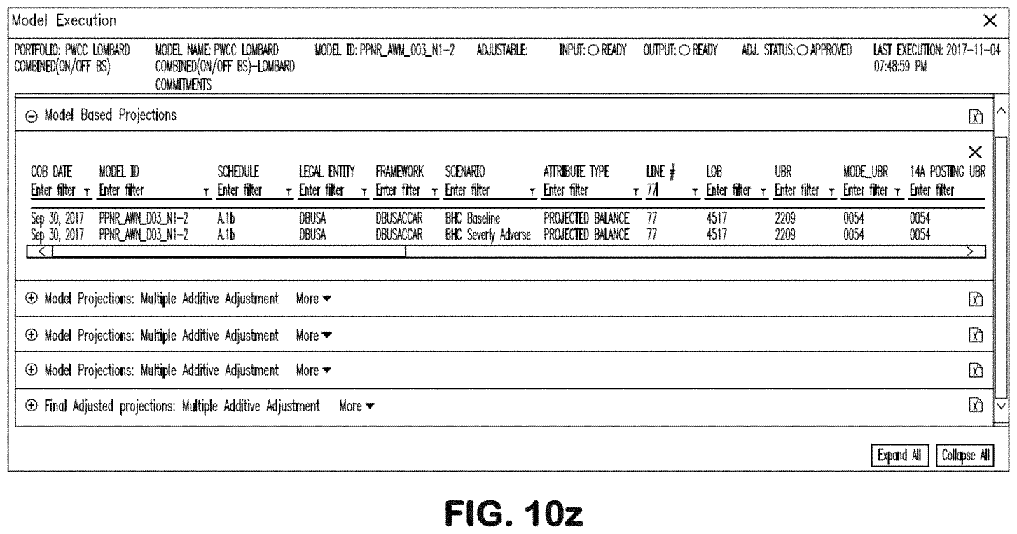

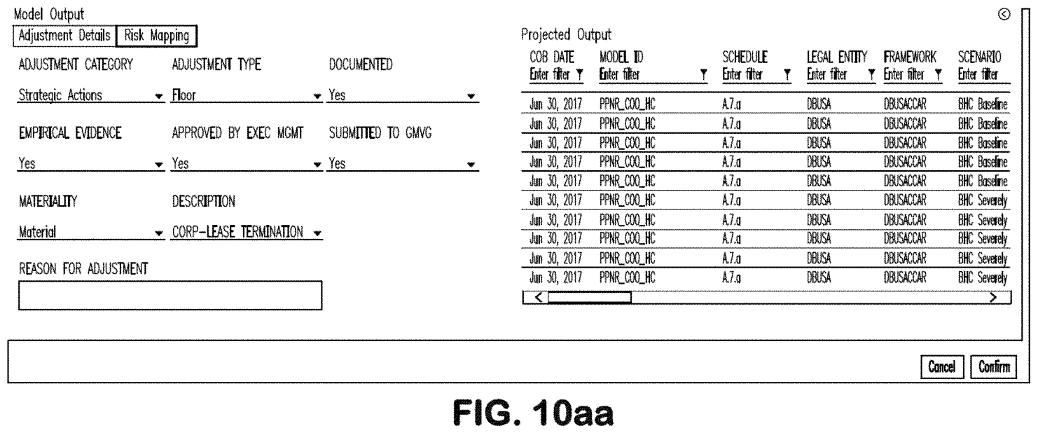

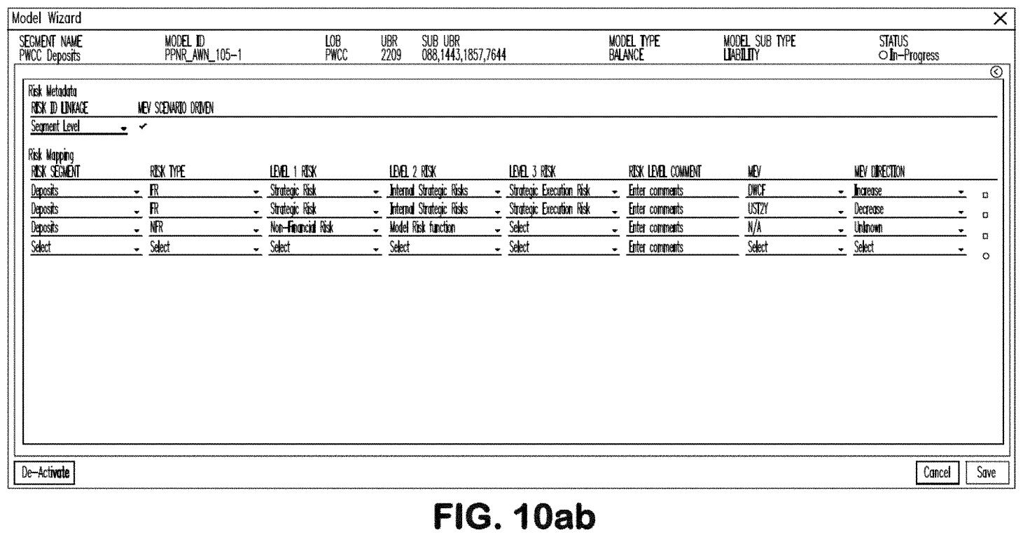

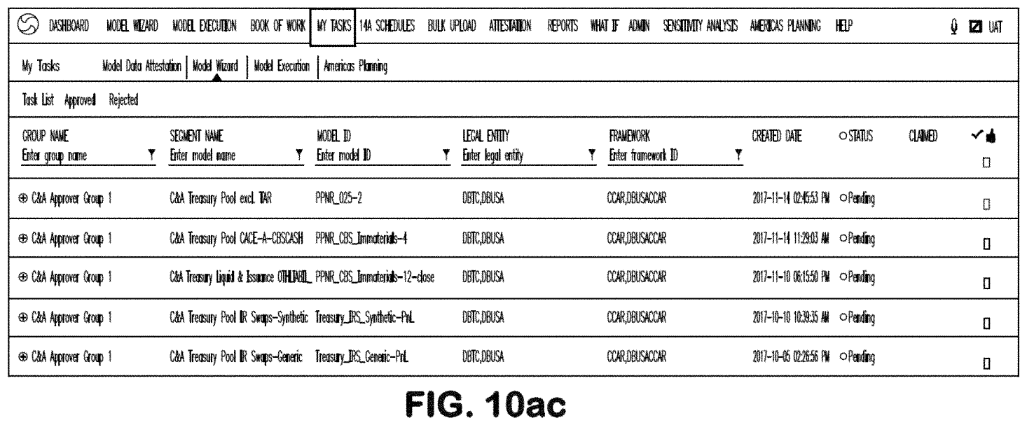

The model execution engine 212 process is triggered based on event-based architecture where, once it is determined that the model input is available in step 210, the ACTIVE from model repository are executed in step 218 (JavaScript model calculation using JavaScript Engine 2181 and R based models calculation using R Engine 2182), and if the model execution is successful, the model output is generated in step 220 and stored in the data store 210. The user interface 102 (which often includes at least one display, a keyboard, a mouse, a microphone, etc.) allows users to view all the details of every step of the way depicted in FIG. 2. See, for example, the screenshot of FIG. 10a, which displays to the user the model language, the risk metadata, the risk mapping, the model input(s), the model equation, and the model output (BHC baseline and BHC severely adverse).

Process for Create/Edit Models Step 204 for Javascript Models and Step 205 for R Calculation Based Models

FIG. 3 illustrates an example of the process flow for creating a new JavaScript based model 204 or editing an existing model 204 from the model repository step 214 OR editing imported R based new model 205 or editing existing R based model from the model repository step 214, which is stored in the data store 210.

Referring now to FIG. 3, at step 301, the process checks user entitlement for whether he/she will be able to create/edit models or view models in view mode only. The model execution environment supports 4 user entitlement roles—modeler/forecaster, approver, Admin, and read only user. If the user entitlement/role is ‘forecaster’ for a specific business area or a process group, then the user will see all models from that business area/process group in his/her queue which he or she is entitled to edit or create new models.

At decision step 302, if the user has a forecaster role, an edit/create model button will appear in the user interface 102, and the user can then proceed. For all other entitlements/roles listed above, users can view models from their business area/process group in ‘read only’ mode.

If the user does not have forecaster rights, he/she is granted read-only rights in step 303. If the user is a forecaster in step 302, the process proceeds to step 304 for entering model metadata which covers model properties such as business segment, model type, model classification—feeder/main and model input and output mappings as per firm's reference data. FIG. 10b shows a screenshot of this step, displaying model metadata (segment name, model type, model subtype, model segment, legal entity, 14A posting, adjustment allowed, model inventory ID, and classification), model input (LOB, UBR which stands for unternehmensbereichsrechnung—a name given to management account structure in Deutsche Bank Group, model UBR, and 14A posting UBR), model schedule and line number, and override output data (LOB, UBR, model UBR, 14A posting UBR, schedule, and line number).

After the metadata is added and/or edited, the process proceeds to step 305 where model input attributes are added and/or edited. By model input attributes, we refer to input financial, market, business historical/spot/projections and reference data attributes that are used to execute the model. FIG. 10c is a screenshot showing the feed input (MEV (Macro Economic Variables) variables, input segment, attribute type, quarter, function), Jump-off feed view (Jump-off means starting point/time-period for model calculation, usually refers to the financial data from the last quarter end date denoted with time-period as Q₀ in model equations) (model UBR, schedule, line number, segment, attribute, quarter, and selected), and related model(s) (selected approach type and model name).

After the model input attributes are added and/or edited in the step 305, the process proceeds to step 306 where model risk attributes are added and/or edited. By model risk attributes, we refer to the risk details such as risk segments and the known risk type/level attributes as defined by Deutsche Banks' Enterprise Risk management team that the model is calibrated to cover/account for. FIG. 10d shows a screenshot for this step, including risk metadata (risk ID linkage, MEV scenario driven), and risk mapping (risk segment, risk type, level 1 risk, level 2 risk, level 3 risk, risk level comment(s), MEV, and MEV direction (direction means whether a change in the MEV used/referenced in the model equation increases/decreases/does not change the specified risk and expected losses for the model or MEV impact is unknown)). FIG. 10d shows the model wizard including risk metadata and risk mapping.

After the model risk attributes are added and/or edited in the step 306, the process proceeds to step 307 for specifying one or more model equation(s), preferably in mathematical form using a MathJS expression library. Math.js is an extensive math library for JavaScript and Node.js. It features big numbers, complex numbers, matrices, units, and a flexible expression parser. FIG. 10e is a screenshot showing this step, including the model equation and the equation viewer. The shown model equation includes Industry fees, quarter 1 dummy [explain dummy], and quarter 4 dummy. FIG. 10f is a screenshot of this step showing the model equation, the equation viewer (showing the mathematical operands, variables, MEV (discussed above), jump off (also discussed above), related model(s), constants, and mathematical operators), and the equation viewer (showing the mathematical equation(s). FIG. 10g is another screenshot displaying another model equation, the equation viewer (showing the mathematical operands, variables, MEV, jump off, related model(s), constants, and mathematical operators), and the equation viewer (showing the mathematical equation(s)). In case of model is imported R based model 205, in that case R based equation will be a read only equation, and the user is not required to explicitly write the equation. Instead, the user can use the same R equation for calculation.

Model equation(s) can take any form. In its simplest form, a model equation(s) could be a flat-line model with a constant value being projected for the full forecast horizon (13 quarters for balance sheet projections and 9 future quarters for NIE/NII/NIR/Tax/RWA projections). The Table 1 below represents a variety of examples model equation types supported by the model execution environment but not limited to the types of model configurations supported in the present invention.

| Type | Example |
|---|---|
| Flat-line ‘0’ | Balance(q) = 0 |
| Flat-line | Balance(q) = c, where ‘c’ is a constant value |
| constant value | |
| Constant value with CASE statement based on projection quarter | $\begin{matrix}Balance := getBalance ( qNoFinYear ) \\ getBalance \text{=} \text{>} qNoFinYear = \{ \begin{matrix}476000000 & qNoFinYear = 1 & qNoFinYear = 3 \\ 567000000 & qNoFinYear = 2 & \\ 367000000 & qNoFinYear = 4 & \end{matrix}\end{matrix}$ |
| Constant value with CASE statement based on Macro- economic value driver/drivers | $\begin{matrix}FundsNetion \text{?} sQ := NetFlow ( SP {500}_{Q} , SP 500 \text{?} ) \\ NetFlow \text{=} \text{>} SP {500}_{Q} , SP {500}_{Q - 1} = \{ \begin{matrix}3.01 & ( SP {500}_{Q} - SP {500}_{Q - 1} \geq 18.79 ) \\ - 0.04 & ( SP {500}_{Q} - SP {500}_{Q - 1} \leq - 93.42 ) \\ 2.16 & ( SP {500}_{Q} - SP {500}_{Q - 1} > - 93.42 ⋀ SP {500}_{Q} - SP {500}_{Q - 1} < 18.70 )\end{matrix}\end{matrix}$ |
| Flat-line based on previous quarter value | Balance(q) = Balance(q − 1) |
| Flat-line based on 4-quarter historical average | $\begin{matrix}Balance ( {q}_{0} ) = \frac{{\sum }_{\text{?}}^{\text{?}} Balance ( q )}{4} \\ Balance ( q ) = Balance ( q - 1 )\end{matrix}$ |
| Linear Regression with | Balance := 0.00002625•IBOXXFIN13_{Q} + 0. [symbol] •IBOXXFIN35_{Q} − |
| one MEV driver with no | 0. [symbol] 3125_{Q} •IBOXXFIN57_{Q} − [symbol] 001•EURUSDGC_{Q} |
| time-period lag | |
| Linear Regression with one MEV driver with time period lag | $Balance := {Balance}_{Q - 1} \cdot exp ( \frac{( 4.03 \text{?}}{100} )$ |
| Linear Regression with multiple MEV drivers | $DDADepositsBalance := {DDADepositsBalance}_{Q - 1} \cdot exp ( \frac{\begin{matrix}( \text{?} - ( \text{?} ( \frac{\text{?}}{\text{?}} - 1 ) \text{?} ( \text{?} AP {\text{?}}_{Q - 1} \text{?} ) - \\ ( \text{?} \text{?} ) \text{?} )\end{matrix}}{100} )$ |

[symbol]

indicates data missing or illegible when filed

After the model equation(s) are added and/or edited in the step 307, the process proceeds to step 308 where the user can save the model in a draft or final state before proceeding with validate and submit models steps 206/208. Note that the user can save his/her work at every step in the create/edit model process 204 and 205.

Process for Validate/Submit Models Steps 206/208

FIG. 4 illustrates the preferred process steps for validating a model 206 and/or submitting a validated model 208 for approval 210.

Referring now to FIG. 4, at step 308, users can open a draft (In-Progress) model using the user interface 102. By Draft (In-progress) model, we refer to a model that is configured till model equation step but hasn't been validated or validated but hasn't been submitted for approval. All draft models are stored in data store 210 in a staging table instead of the tables where ‘ACTIVE’ models are stored to ensure the correct model version is used for execution purposes. FIG. 10h is a screenshot of this step, showing the feed input (ME MEV variables, input segment, attribute type, quarter, and function), related model(s) (selected approach type, model ID, and model name), and the jump-off feed view (Model UBR, schedule, line number, segment, attribute, quarter, and a checkbox showing whether the UBR has been selected.

At step 309, the user can add model input data. To validate a model, user would need to input/key-in the input variables that one would require to use to execute the model in real-time. Validate model step is a crucial step in model setup process as the validation results are stored and available in the user interface 102 for model approvers to review the output results and use it as part of their approval process. In FIG. 10i, a screenshot of this step is shown, including model validation (with scenario), jump-off attributes (Quarters and DDA (DDA stands for demand deposit account which is a type of deposit account) deposits balance, and parent model output/MEV variables (such as by quarters, DWCF (DWCF is the short name for Dow Jones Total Stick Market Index), SWAP2Y (SWAP2Y is the short name for 2Y USD Swap Rate in %), UST2Y (UST2Y is the short name for Benchmark 2-Year US Treasury yield in %), BBB (BBB is the short name for US BBB corporate yield for 10Y BBB-rated corporate bonds in %), and projections).

After step 309, the model is validated at step 310. FIG. 10j is a screenshot showing an exemplary step 310, including model validation, jump-off attributes (including quarters and DDA deposits/balance), parent model/MEV variables (such as by quarters, DWCF, SWAP2Y, UST2Y, BBB, and projections). FIG. 10k is a screenshot showing the input variables loading. And FIG. 10l is a screenshot showing the model validation, jump-off attributes, and parent model output/MEV variables after loading.

Thus, as part of the model validation, once the user selects the scenario and keys-in model input data on the top left-hand side of the model validation screen and clicks the ‘Validate’ button, the model is executed using the model equation via the execution engine and the output is made available in the same screen in the right-hand side of the model validation screen. Upon successful validation, the ‘Submit’ button is enabled for the forecaster/modeler to submit the model for approval.

After step 310, the process proceeds to step 311 where it is determined whether the output of step 310 is expected or not. In step 311, the user reviews the results and if they are as per his/her expectations, he/she can submit the model for approval at step 312 or revert to the edit model configurations including any step of edit model metadata step 304, edit model input attributes step 305 or edit model equation step 307 in FIG. 3. The user generally refers to the model documentation or their offline excel spreadsheets to verify the output displayed on the model validation screen to make the decision whether the model has been configured correctly or not. Upon verification, the users may choose or use their discretion to submit the model for approval. FIG. 10m is a screenshot showing this step, including the spread sheet on the left side and the model validation on the right side.

If, at step 311, the output is unexpected, the user adds and/or edits the model equation. To do this, the user can navigate through to the model equation page and click on the ‘Edit’ button and open the equation editor and make the necessary change. The screenshots in FIGS. 10n and 10o show the 1^{st} and 3^{rd} constants being changed from ‘6.15112997153207’ to ‘7.15112997153207’ and ‘8.11404548401521’ to ‘9.11404548401521’. Once the changes are done, the user can save the updates by clicking on the ‘Save’ button at the bottom of the screen, as per FIG. 10p.

Architecture Overview

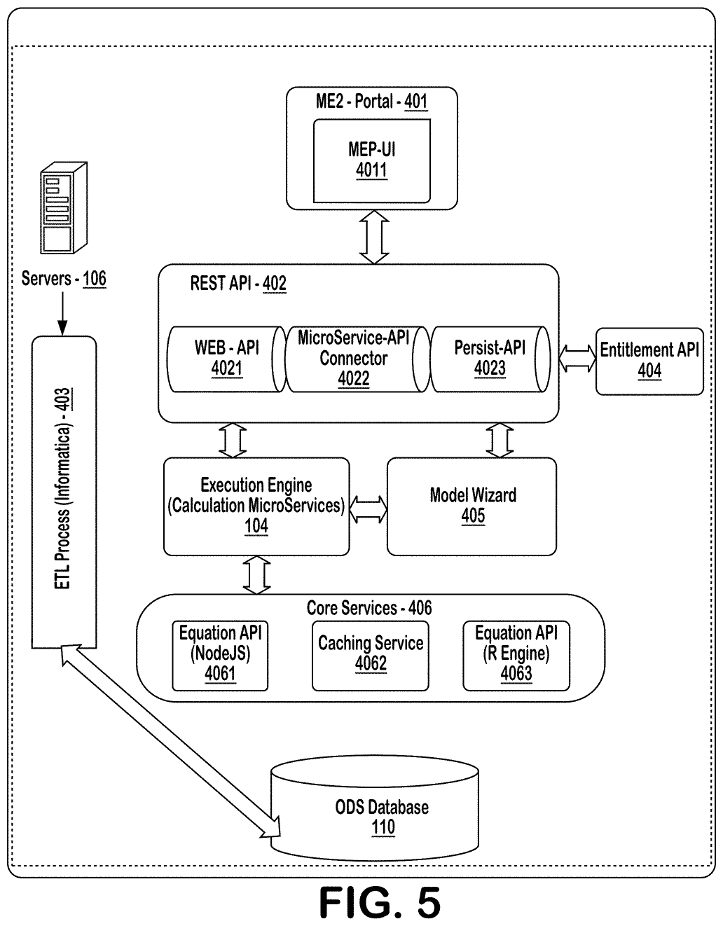

FIG. 5 is a block diagram that illustrates the high level functional architecture of the computer system 100 upon which an embodiment of the present disclosure may be implemented. Information to/from the user 101 is provided through the server(s) 106, as discussed above. That information is processed by an Extract, Transform, and Load (ETL) process (from Informatica) 403.

The computer system 100 preferably includes a presentation layer Me2 portal 401, preferably built in AngularJS/HTML5, and comprising of Model Execution platform (MEP) User Interface 4011. The computer system 100 also includes a service layer/REST (representational state transfer) application programming interface (API) 402, preferably built using Spring Boot (from Pivotal Labs) and activity Business Process Management (BPM). Preferably, the REST API 402 includes a Web API 4021, a service API 4022, and a Persist API 4023. The REST API accesses an entitlements API 407. Entitlements API is Deutsche Bank's centralized entitlements framework which most applications and platform use for user access authorization. Most firms have similar access/entitlements frameworks in place which is access via a common web-service based API/interface which one can use/integrate with minimal code change.

The execution engine 404 executes the functions described above with respect to FIGS. 2 and 3, using computer code stored in ROM and/or RAM. The model wizard 405 executes the functions described above with respect to FIGS. 2 and 4, using computer code stored in ROM and/or RAM.

A persistence layer 406 is provided, preferably using Spring Boot, MyBatis (from MyBatis, a subsidiary of iBATIS), and Hazelcast (from Hazelcast, Inc.). The persistence layer 406 preferably conducts core services, using and equation API 4061 for JavaScript models (preferably using NodeJS from the Node.js Foundation). Caching services 4062 are provided for data caching. Equation API 4063 is used for R model calculation.

The core services 406 in FIG. 5 are preferably invoked via three possible ways: (i) via a feed file dropped on the server(s) 106 and picked by ETL (ETL is a standard data—processing framework and stands for Extract, Transform and Load) process 403 and input stored in data store 110 which then calls the equations API 4061 for JavaScript model or 4063 for R based model to execute the models and then store the output back in the data store 110. The caching service 4062 is used to store all the input data into Hazelcast cache for using it for model execution rather than making a data—base call to the data store 110 for every calculation step; (ii) via a user submitting a sensitivity analysis scenario through Me2 Portal 401 which calls the Entitlements API 404 to check user authorization, uses Service API 4022 to then run the Execution Engine 104 using the Equations API 4061 for JavaScript model or Equation API 4063 for R based model calculation and storing the input & output into the data store 110; and/or (iii) via a user submitting a ‘validate model’ request through Me2 Portal 401 which calls the Entitlements API 404 to check user authorization, uses Service API 4022 to then run the Model Wizard Engine 405 using the Equations API 4061 for JavaScript model and Equation API 4063 for R calculation based model and storing the input & output into the data store 110.

In operation, the execution engine 104 loads metadata for all models in the model repository 214 store in the database 110 and/or files provided through the ETL process 403, executes different calculations on the model(s), taking the input from source tables and stores calculated data for different models in the database 110.

Model Execution Engine Component Architecture

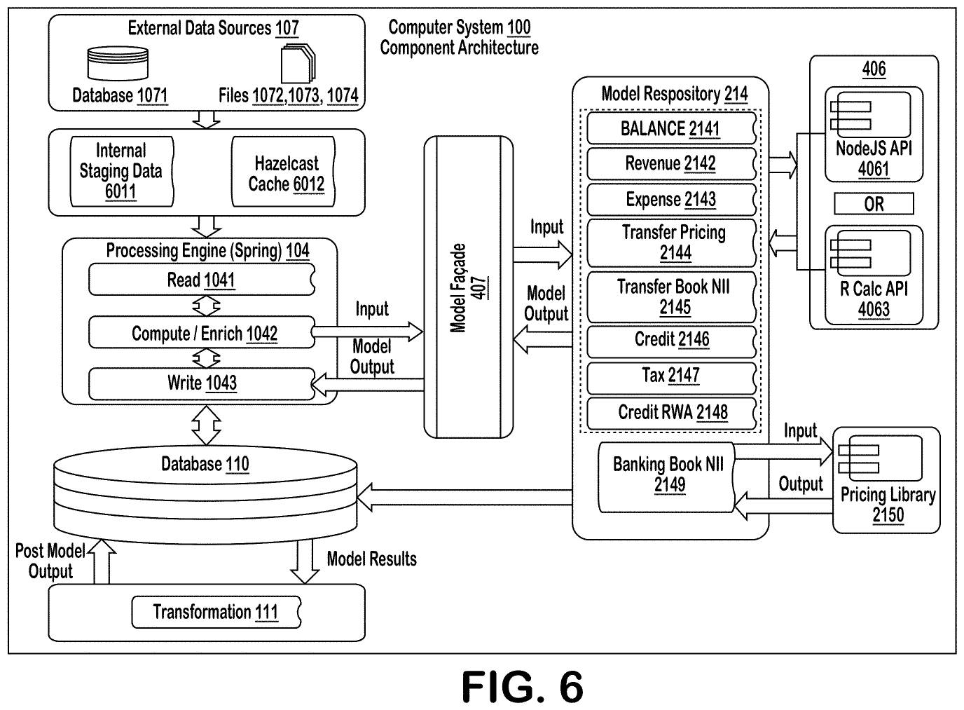

FIG. 6 illustrates in a detailed functional block diagram of an example computer system 100, with component architecture for the execution engine 104, upon which an embodiment of the present disclosure may be implemented.

Initially, information/data may be acquired from one or more external data source 107, which may include, for example, information/data from financial database 1071 and/or business file(s) 1072-1074. This information/data may be provided to a processing module 601, which may include internal staging module 6011 which is a collection of tables to store model data used as an input for model execution, and a caching service 6012 (which may comprise a Hazelcast cache from Hazelcast, Inc.) to store all input data in-memory for model execution to avoid making direct calls to the database for every query for model execution calculation or for Me2 UI 102 display.

The processing (execution engine) 104 preferably includes three main components: (i) a Spring batch reader 1041, which reads the information/data from the internal staging data module 6011 or cache service 6012, and passes it to (ii) a preprocessor/enrich/compute module 1042 which will take input from the reader, preprocess the data, enriches it (if required) and calls Model Façade with required parameters (iii) a write module 1043 which writes model output data to database Data/information is provided to/from a model façade module 407. Façade is a java based routing channeling mechanism and works as a gateway to the Model Repository 214, and based on different model types, it call to various MicroService based model calculators.

It takes the desired parameters as input from the Compute module 1042 and calls the models from Model repository 214 based on the trigger process discussed above. It preferably passes the output of the specific model/models to the compute/enrich module 1042 for further processing/storage before calling the write module 1043. This process is applicable to all types of models discussed above.

The model repository preferably stores collection(s) of information/data regarding the parameters which may be used in one or more model type. That storage may include: a balance store 2142, which stores a collection of balance sheet models covering assets and liabilities models; a revenue store 2142 which stores a collection of non-interest revenue (NIR) models; and an expense store 2143 which stores a collection of non-interest expense (NIE) models including sales and marketing transfer pricing (SMTP) and trader management services fee (TMSF) models; a trading book Net Interest Income (NII) model(s) which may store a collection of trading book NII models; and a credit store which may store a collection of wholesale credit models including probability of default (PD) models, loss given default (LGD) models, and exposure at default (EAD) models which are used to calculated credit losses. The model repository 214 may further include: a tax store 2147 which stores a collection of tax models that compute deferred tax assets (DTA) and deferred tax liabilities along with tax projections; and a credit Risk weighted Average model(s) (Credit RWA) store 2148 which stores a collection of counterparty credit RWA and general RWA models.

The model repository 2414 preferably also has a banking book NII store 2149 which stores a collection of banking book (loan portfolio) NII main and feeder models. The banking book NII 2149 preferably communicates with DB's authoritative pricing library 603 stored in server(s) 106 used to price loans/securities and over the counter (OTC) derivative trades which store(s) pricing models to calculate future cash-flows for the loans and securities within the banking book portfolio and exchanges input/output to/from the banking book NII models 2149. The process involves, invoking banking book NII models 2149 and in turn using the pricing library 603 to price the banking book NII loans and portfolios, getting the future cash-flow output and further aggregating the interest income and expense to get the net II results by each portfolio. It may be worth noting that there is no physical transfer of data to any external pricing or calculator outside the presented computer system 100.

The model repository 2414 preferably uses core services API 406, which has an option to either use NodeJS API 4061 for multi-threaded/distributed model execution calculation processing, or a native java RhinoJS API (available from the Mozilla Foundation) for concurrent model execution calculation processing during peak processing time for any JavaScript based models OR uses Equation API 4063 for multi-threaded/distributed model execution calculation processing for R models calculation, which does calculation for models which are built based on R language and follow R language standards. The system is preferably configured with all these APIs to make the best use of processing power when needed and to support various models either built with JavaScript or R language.

The processing engine 104 also communicates information/data to/from the database 110. Once models are executed, the model output/results are stored into the data store 110 via the transformation module 606 to enrich the data as per business reporting format. The data store 110 provides model results to the module 606 for display and reporting purposes, called-up and viewed by the user 101 via the user interface 102.

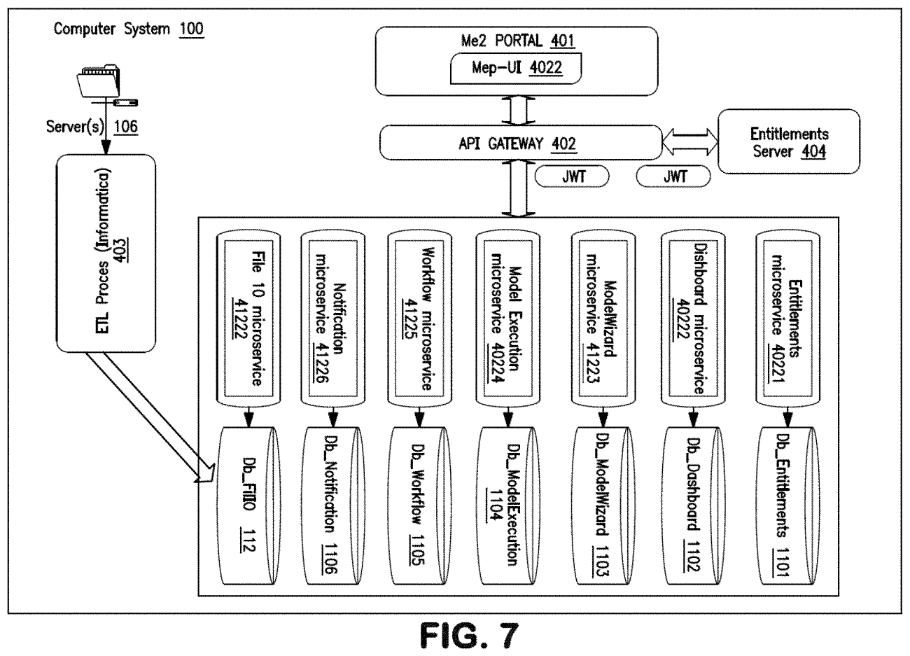

FIG. 7 is a block diagram that illustrates a computer system 100 high-level alternate architecture vis-à-vis FIG. 5, upon which an embodiment of the present disclosure may be implemented.

The computer system preferably includes a presentation layer Me2 portal 401 built in AngularJS/HTML5, an API gateway using rest API and Jason Web Token (JWT) 402, preferably built using Springboot and activity BPM, a micro-service based API for each module/service 40221-40227 and database for individual services 1101-1107.

The functionality preferably remains same between FIG. 6 and FIG. 7, the difference in FIG. 7 being the technical implementation using micro-services, which makes the design modular as each functionality is segregated by a separate micro-service

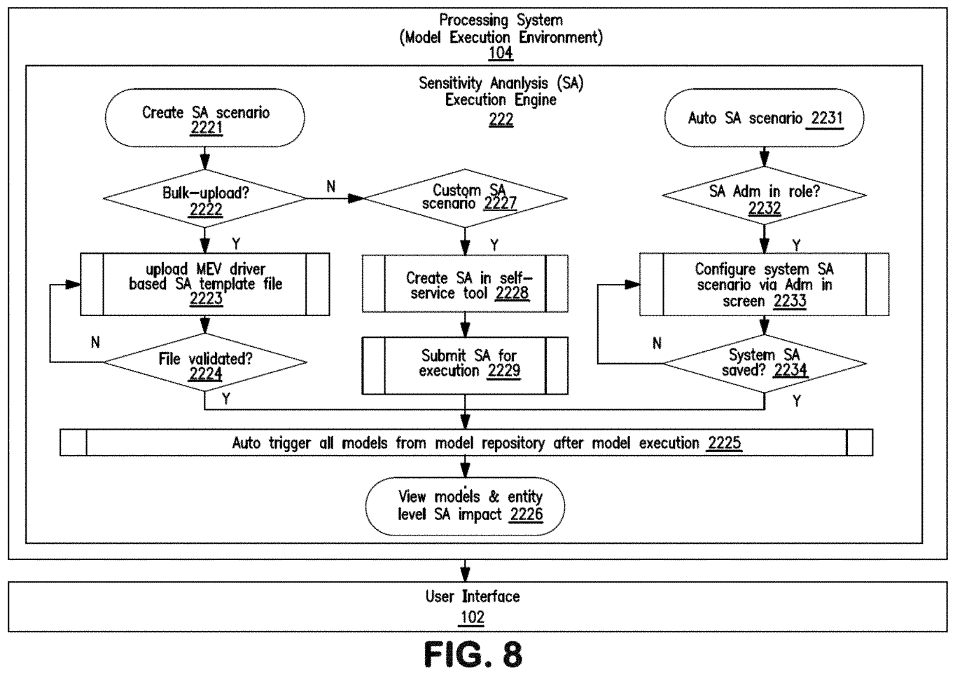

FIG. 8 illustrates an example process flow for performing sensitivity analysis 222 using active models from the model repository 214.

Referring now to FIG. 8, at block 2221, the process checks users entitlement for whether he/she wants to create automated sensitivity scenarios 2231, bulk-upload sensitivity scenario 2222, and/or create custom sensitivity scenarios 2227.

Upon entitlements authentication and user action, sensitivity scenarios are created 2223, 2228, 2233 with an option for the user to include or exclude model adjustments. Once impacted models are executed 2225, the model level and entity level impact results 2226 are available in the UI 102. The below screenshots illustrate UI for blocks 2227, 2231, 2232 in that order 2227. FIG. 10q is a screenshot showing choices among dashboard, model wizard, model execution, book of work, my tasks, 14A schedules, bulk upload, attestation, reports, what if, sensitivity analysis, America's planning, and help. FIG. 10r is a screenshot showing the sensitivity analysis choice of FIG. 10q, including save system sensitivity as (legal entity, framework, adjustment, scenario, standard deviation). FIG. 10s is a screenshot showing a 2232 sensitivity analysis including categories for my sensitivity analysis, others sensitivity analysis, system sensitivity analysis, bulk sensitivity analysis; a selection of the sensitivity analysis type (including MEV specific); a download template; a select file to upload; and a sensitivity analysis upload history (including user name, date/time, file name, total sensitivity analysis, processed sensitivity analysis, and unprocessed sensitivity analysis).

FIG. 10t is a screenshot showing a 2232 sensitivity analysis including categories for sensitivity analysis, my sensitivity analysis, others sensitivity analysis, system sensitivity analysis, bulk sensitivity analysis, and action choices such as create new system sensitivity, create new, and export. Under my sensitivity, for example, the user may provide favorites, last updated user, last execution, output status, review status, sensitivity type, bulk run, and delete. FIG. 10u is a screenshot showing the sensitivity details screen, including test, name, date, organization. Screen quarter panels are provided for: SA configuration (including sensitivity name, legal entity, sensitivity type, scenario); impacted model metadata change (including total assets, total liabilities, NIR, NII, RWA); model level values, post-impact delta value (including total assets, total liabilities, NIR, NII, and RWA); and entity level values, post-impact delta values (including total assets, total liabilities, NIR, NII, NIE, PPNR, tax, net income, retained earnings, and CET1 (CET1 stands for Common Equity Tier 1) capital).

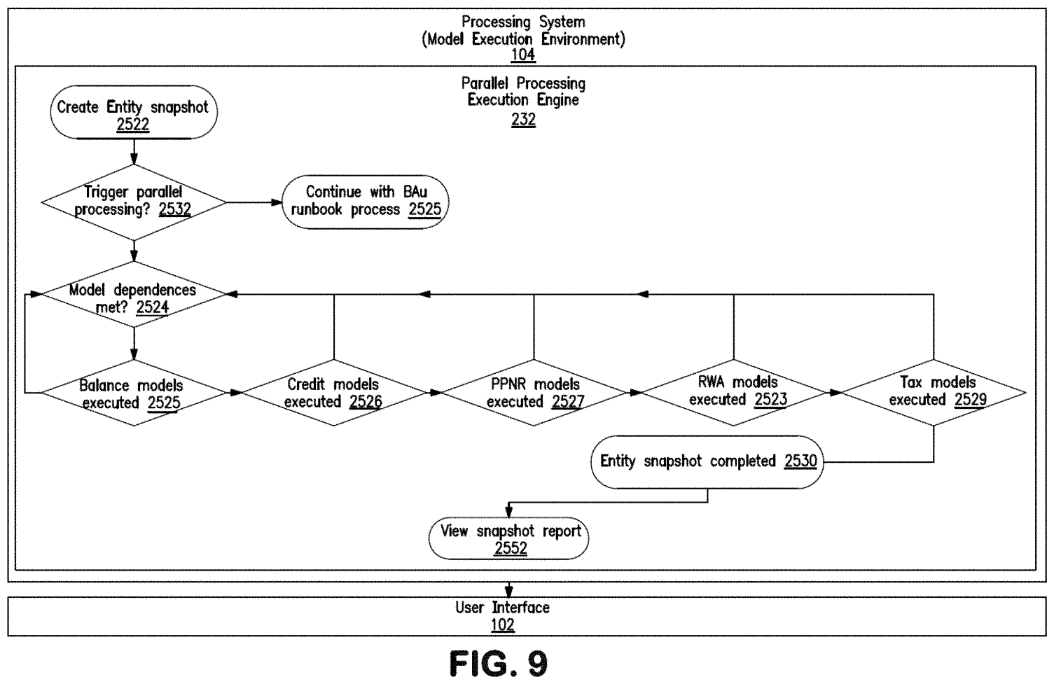

FIG. 9 illustrates an example process flow for parallel processing of all the models in model repository for performing entity level snapshot. FIGS. 10v, 10w, 10x, and 10y screenshots shows the user interface for creating a snapshot and detailed execution. In FIG. 10s, the admin screen has choices for STP (STP stands for Straight-Through-Processing), scenario map, parallel processing snapshot, model wizard settings, STARR (STARR is an aggregation module within STEP and stands for Stress Testing Aggregation and Regulatory Reporting), and outbound feed. The snapshot may be denied if there is a 5 step request pending, 5 data attestation task(s) pending, and/or input files not received. Choices may be made for snapshot history (e.g., COB date, snapshot name, created by, created on, status, and comments), STP process, data attestation, and feed issue. FIG. 10w is very similar to FIG. 10v, but shows the STP process choice (including legal entity, framework, LOB, model type, model ID, and status). FIG. 10x is also similar, but showing the data attestation choice (including group name, model type, feed type, line of business, legal entity, framework, create date, and status). FIG. 10y is also similar, but shows the feed issue choice.

Referring now to FIG. 9, at block 232, the process checks users entitlement for whether he/she wants to create entity level snapshot and then proceeds with either checking whether all model dependencies are met 2324 which includes feed and data attestation dependencies or continuing with the BAU runbook process 2323 which is limited to one or more processes being executed at a time but not all.

If model dependencies are met, the models from model repository 214 are executed in a sequential order one after the other 2325-2329. Once all model are executed, snapshot process is completed 2330 and entity level snapshot report 2331 is available via user interface 102.

Some embodiments may be provided in a computer program product that may include a non-transitory machine-readable media having stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Thus, what has been described are apparatus, methods, and computer-readable media embodiments whereby data processing structure receives at least one input representing historical and/or spot financial, market, business, reference, and/or static data. A controlled and audited self-service tool called model wizard with activity BPM approval workflow process lets users create, edit, and/or approve driver-based regression models for stress-testing and entity-planning purposes.

Regression models in their simplest form involve (i) an unknown parameter, (ii) independent variable/variables, and (iii) at least one dependent variable. A regression model relates Y to a function of X and β, Y≈f (X, β). An example of a linear regression model would be

With active BPM approval workflow capability, the system has the ability to capture and store the model version and change history throughout the life-cycle of a model, which lets users and internal and external auditors view how models have gone through changes in the system since they were created the first time. An execution engine is provided, preferably using open-source technologies, which allows faster and more efficient model execution, which may also be used for running sensitivity analysis and “what-if” scenarios.

A user interface is provided to view model details with an ability to apply discrete model adjustments such as strategic actions or idiosyncratic events that the models may not have accounted for, distinguished by adjustment category, type, and description (among other attributes as shown in FIG. 10z. This capability allows the system to capture every adjustment that is made in the system on model outputs which can be easily used for attribution analysis in term of adjustment impact to the entity level ratios/numbers. In FIG. 10z, the model execution screen has selections for portfolio, model name, model ID, adjustable?, input, output, adjustment status, last execution date. The model based projections panel shows COB date, model no., schedule, legal entity, framework, scenario, attribution type, line number, LOB, UBR, model UBR, and 14A posting UBR. Other selectable panels include: several panels for model projections, multiple additive adjustment; and final adjusted projections, multiple additive adjustment. FIG. 10aa shows a screenshot for the model output, including selections for adjustment details and risk mapping. For adjustment details, information is provided for adjustment category, adjustment type, documented, and projected output (including COB date, model no., schedule, legal entity, framework, and scenario). Such screens provide a workflow module configured to assign a model-approval task to an approver. Preferably, functionality is also provided to store and utilize a central model repository of both ‘DRAFT’ and ‘APPROVED’ driver-based stress test regression models.

Also described above is apparatus including at least one memory device, a processor communicatively coupled to the memory device, and at least one workflow module configured to assign at least one resource from a plurality of resources for model approval of at least one model. Further described above is/are at least one “create new model module” that creates at least one regression model covering at least one level-3 risk type as outlined by an enterprise risk management process for risk classification, as shown in below screenshot of FIG. 10ab. In FIG. 10ab, the model wizard has selections for segment name, model ID, LOB, UBR, sub UBR, model type, and status. The screen has information regarding risk metadata (including risk ID linkage and MEV scenario driven). Risk mapping has information on risk segment, risk type, level 1 risk, level 2 risk, level 3 risk, risk level comment, MEV, and MEV direction.

Also described above is/are at least one least one validation module which validates at least one ‘DRAFT’, and at least one workflow module configured to: submit at least one ‘DRAFT’ and validated model; approve at least one ‘DRAFT’ model and add it to the active model repository. At least one data I/O interface module is preferably provided and configured to provide/receive input data for at least one model to execute it. At least one execution module is preferably configured to: run/execute at least one model and confirm whether output is generated or not; store and view at least one model output in user interface. At least one adjustments module is preferably configured to adjust at least one model output.

Also described above is apparatus of wherein the at least one model comprises at least one of: a built-in model from a set of built-in models of one of the equation forms described above; and a customized model wherein said customized model comprises: at least one dependent variable which could be financial or risk attribute that the model calculates such a balance or revenue or expense etc.; a set of independent variables which could be one or more macro-economic variable (s) such as GDP or VIX or S&P500 or Headcount; a set of data sources for the dependent variable(s), and for the independent variables; and a set of documentation.

Also described is structure/function wherein submitting at least one model for approval comprises generating an automatic workflow task via activity BPM workflow tool within the platform which uses user entitlements API 404 to create tasks for model approvers for them to review and approve model equation changes or model adjustments in the user interface 102 as shown in the screenshot of FIG. 10ac, tabs are displayed for dashboard, model wizard, model execution, book of work, my tasks, bulk upload, attestation, reports, what if, admin, sensitivity analysis, Americas planning, and help. For example, when “my tasks” is chosen, a task list is displayed, along with approved and rejected. Under the task list, information is displayed for group name, segment name, model ID, legal entity, framework ID, created date, status, and claimed.

A system according to embodiments of the present invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

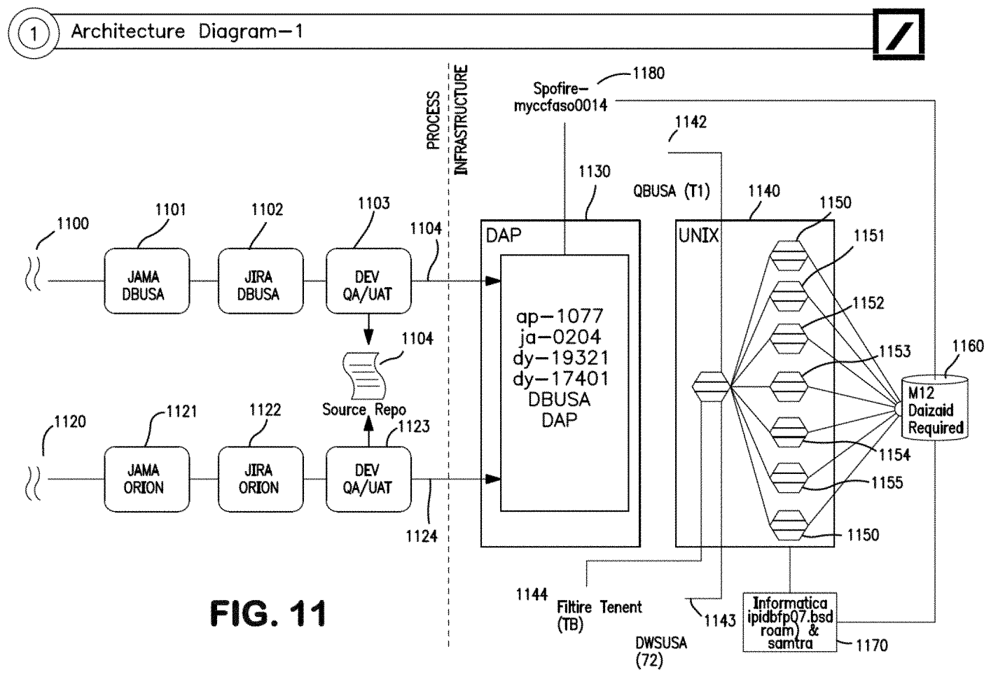

FIGS. 11-19 show another embodiment according to the present invention. The state of SRC platform is capable to support more legal entities to run the CCAR cycles, with their own set of models configuration. It gives high-level of information with both (as of now) DBUSA (Deutsche Bank USA) and DWSUSA (a fund manager), it can accommodate other Legal Entities (aka Tenants of Strategy, Risk and Capital Platform (SRC′) used for CCAR), it can accommodate their own set-of models configured by respective modelers through Model Wizard, those models will be available for execution with proper maker-checker based approval. Legal Entities will have separation of activities through pre-approval entitlements, and it will follow the Chinese walls implementation, so person will have the capability of restriction as well. The underlying infrastructure/servers/deployments are common, but all data is segregated with Legal Entity Id, so though sharing the same infrastructure, they have complete separation on calculation and data perspective. The calculation engine, is enabled with MicroService based architecture. It has one calc-executor service which has the daemon polling for any models available for calculation for specific Legal Entity, and it picks-up for execution. Based on different model type, it calls different calculation engines, for further model specific calculation. As of now, SRC supports B/PPNR, NII, TAX, CREDIT, RWA, My-Task related separate calculators. These calculators are independent MicroService, which can have multiple instances as well, and can be configured independently as required model calculation.

FIG. 11 shows a user 1100 inputting information to JAMA (a Software Development Life Cycle (SDLC) tool to capture requirements from a user and/or a business) 1101 based at DBUSA. This information is processed by JAMA 1101 and provided to JIRA (the SDLC tool to support all development activities) 1102, also based at DBUSA. The JIRA-processed information is provided to DEV (SRC Tech Development Team for development followed by Quality Assurance Testing and once ready users starts performing User Acceptance Testing) 1103. User 1120 inputs information to JAMA 1121 based at Orion [???]. This information is processed by JAMA 1121 and provided to JIRA 1122, also based at Orion (e.g., DWSUSA). The JIRA-processed information is provided to DEV 1123, based at QA (Quality Assurance)/UAT (User Acceptance Testing). The developed software code is then preferably placed with a secure GIT (a free and open source distributed version control system designed to handle everything from small to very large projects with speed and efficiency), (e.g., at DB), which is for source code management, at 1104 and 1124, to DAP (The deployments (.ear files) of software applications deployed under DAP Infrastructure and Unix server) 1130. With the provided information, DAP 1130 runs processes ap-1077; ja-0202; dw-19321; dw-17401; DBUSA; and DAP. At 1131, DAPO 1130 (DAP deployments have all reach user interfaces related deployments, for any Model Validation it gets connect to MicroServices deployed and running under UNIX platform 1140. The UNIX executor 1141 preferably has daemons running, which keep checking for any models available to execute from DBUSA (T1) 1142; DWUSA (T2) 1143; and future tenant (T3) 1144.

The UNIX calculation executor MicroService 1141 calls to different MicroServices for different calculations, such as BPPNR (Balance/Pre-Provision Net Revenue) 1150; credit 1151; NII (Net Interest Income) 1152; Tax 1153; RWA (Risk Weighted Assets)m 1154; NIE (Non-Interest Income Expense], SMTP [Sales Marketing Transfer Pricing], and TMSF [Trade Management) 1155; and System Calc Services 1156. The above-listed MicroServices output their calculation results to one or more ME2 database(s) 1160. Module 1156 also outputs to Informatica (e.g., a third party extract-transform-load technology tool) (pfdbfp07.us.db.com) (server on which Informatica is hosted) and Samba [e.g., aa hard drive used to store and exchange data (used for ME2 calculations) between system to system and through users in a secured manner (with pre-approval access) 1170. The DAP 1130 and the ME2 databases 1160 also provide information to Spotfire (e.g., a third party) nyccfasp0014. The Spotfire Server preferably hosts various reports for analytics 1180.

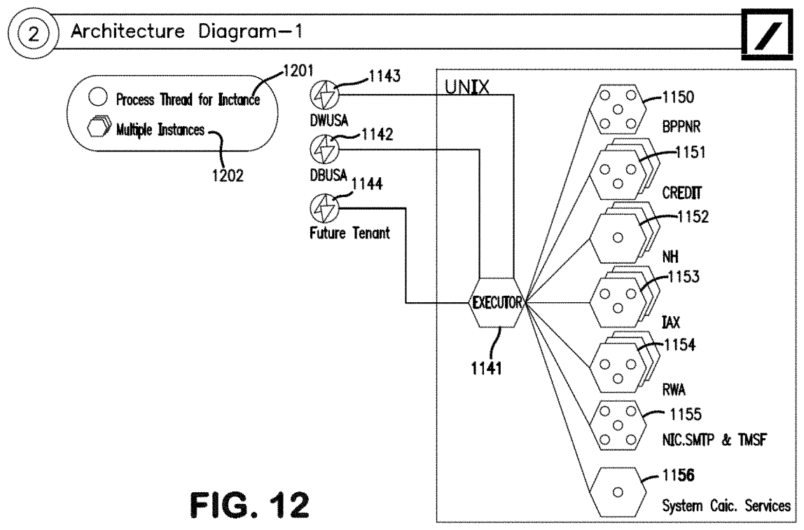

FIG. 12 shows the process thread for instances 1201, and the process thread for multiple instances 1202.

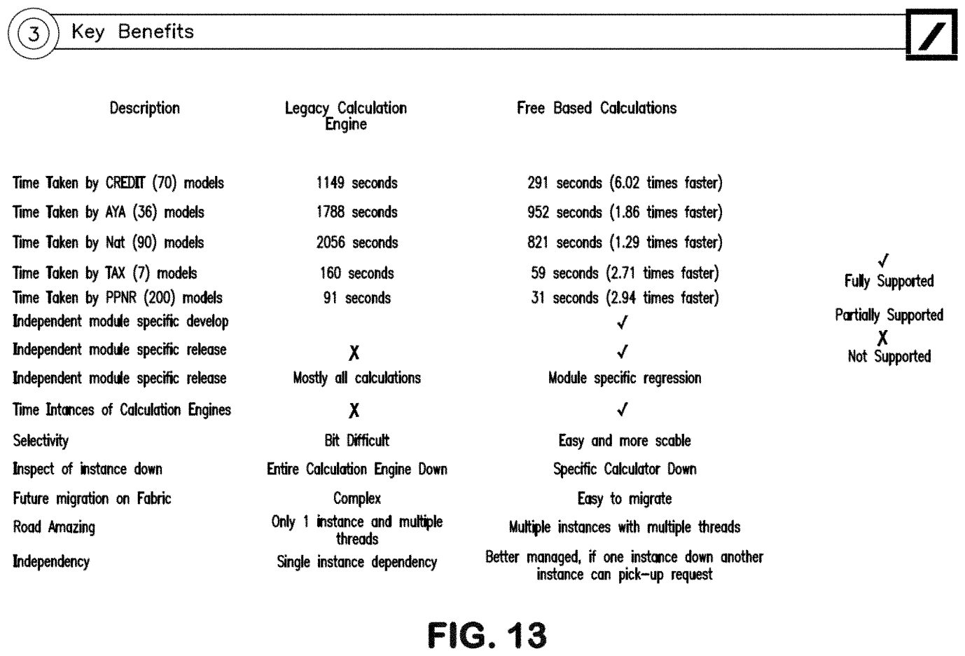

FIG. 13 is a screen shot showing calculation engine time performance for the microservice-based calculation engine. Microservice is a distinctive method of developing software systems that tries to focus on building single-function modules with well-defined interfaces and operations.

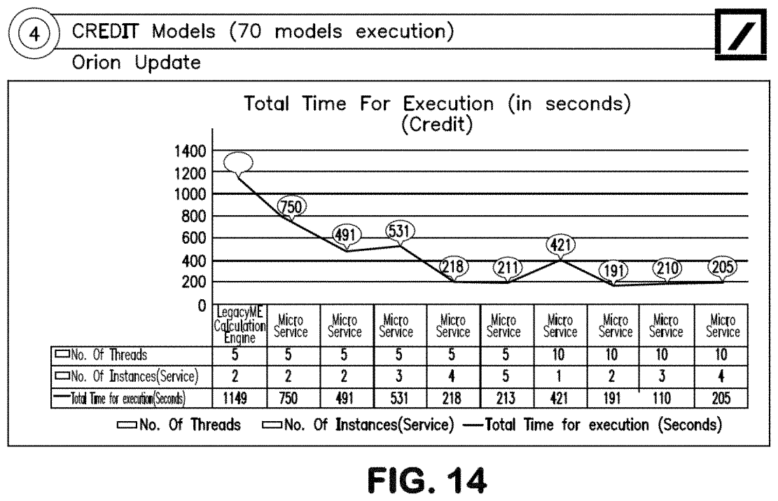

FIG. 14 shows a screen shot for the total time for execution in seconds for the credit module(s) (70 models execution), and the number of threads that can be operated by the various engines.

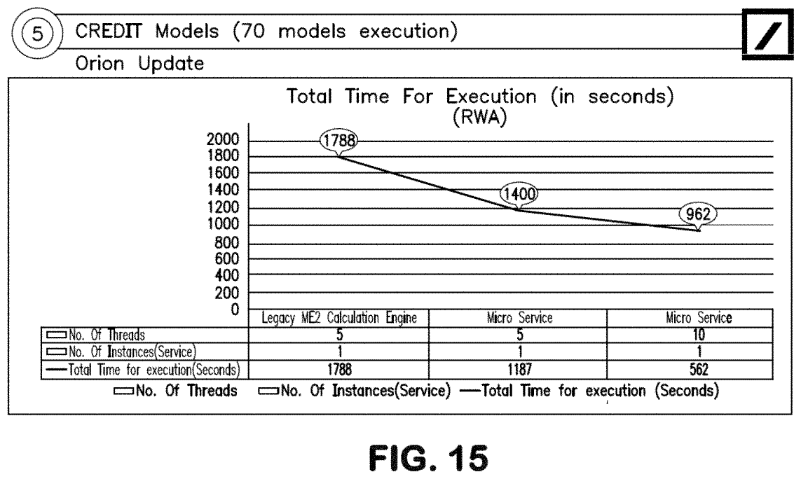

FIG. 15 shows a screen shot for the total time for execution in seconds for the RWA module(s) (18 models execution), and the number of threads that can be operated by the various engines.

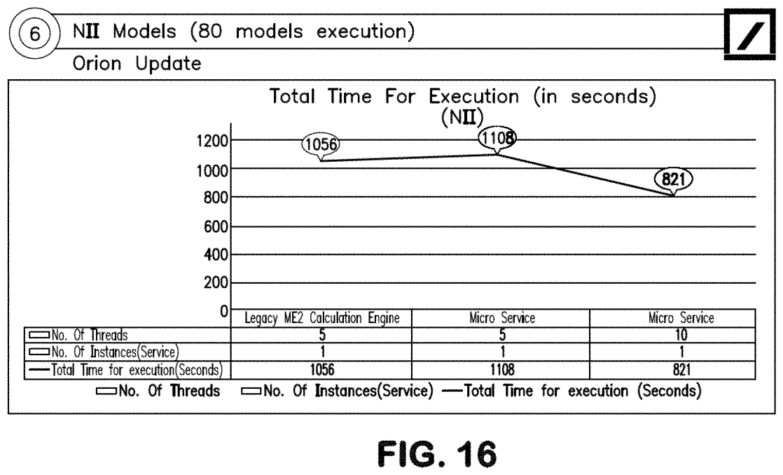

FIG. 16 shows a screen shot for the total time for execution in seconds for the NII module(s) (80 models execution), and the number of threads that can be operated by the various engines.

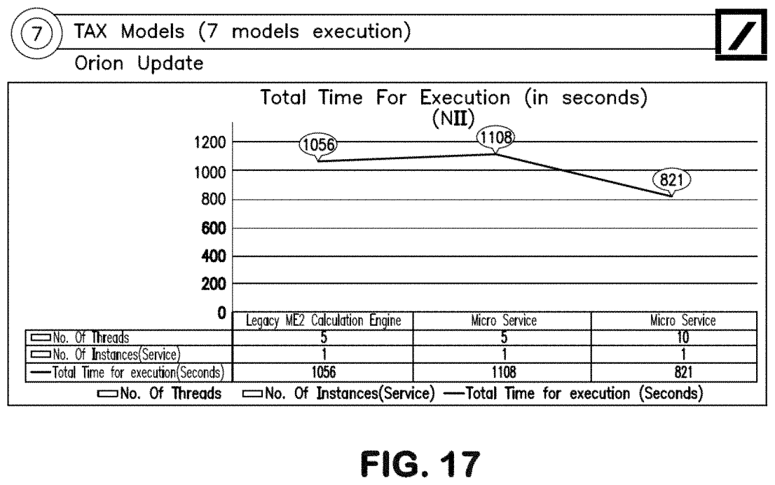

FIG. 17 shows a screen shot for the total time for execution in seconds for the Tax module(s) (7 models execution), and the number of threads that can be operated by the various engines.

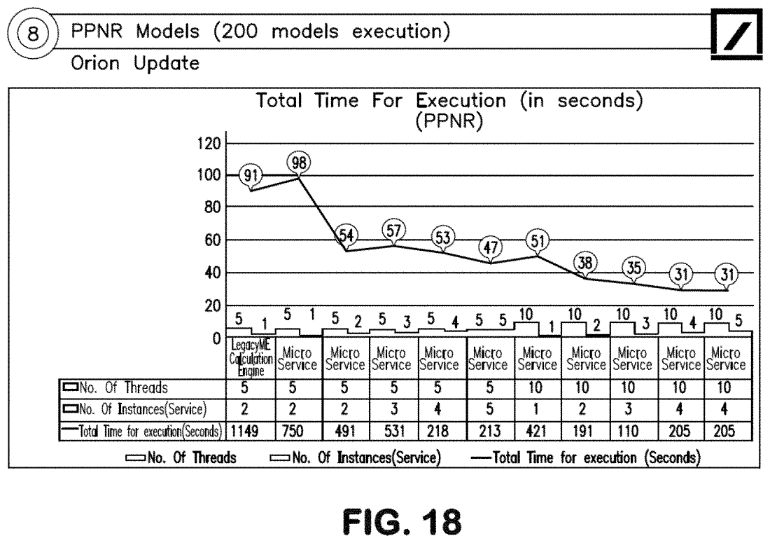

FIG. 18 shows a screen shot for the total time for execution in seconds for the PPNR module(s) (200 models execution), and the number of threads that can be operated by the various engines.

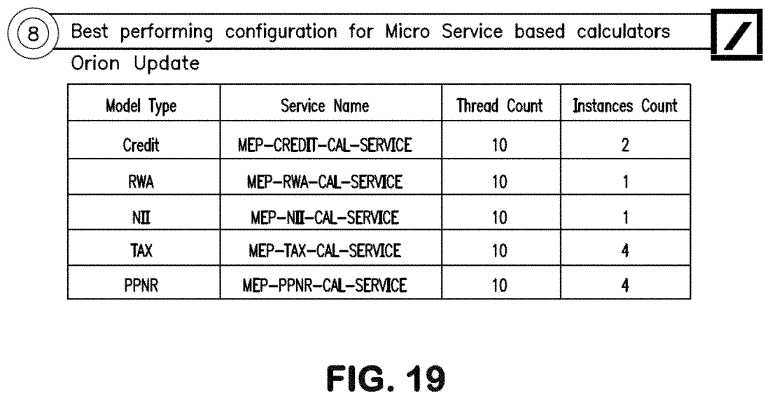

FIG. 19 shows the thread count and instances count for the Credit, RWA, NII, Tax, and PPNR models, using the service names shown.

The individual components shown in outline or designated by blocks in the attached Drawings are all well-known in the electronic processing arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. Apparatus for conducting Dodd-Frank Act stress testing of a financial institution, comprising:
a user interface having a user display, a user input device, and at least one user processor;
at least one stress-test server coupled to the user interface and to least one external data source, the at least one stress-test server having at least one server processor coupled to at least one internal database;
the at least one server processor executing computer program code which provides a model wizard, a model execution engine, and a sensitivity analysis tool;
the model wizard receiving a model to be executed,
wherein the model comprises user inputs from the user interface, the user inputs including: (i) input financial information comprising historical financial data, spot financial data, projected financial data, market financial data, and time data; (ii) risk information, and (iii) model equation information,
wherein the model is an R model or a JavaScript model;
the model execution engine using the user inputs, data from the external data source, and data from the internal database, to execute at least one equation to calculate (i) bank pre-provision net revenue information, (ii) credit information, (iii) tax information, (iv) credit risk-weighted asset information, and (v) capital ratios,
wherein, if the model is an R model, the model execution engine executes the R model using an R engine, and
wherein, if the model is a JavaScript model, the model execution engine executes the JavaScript model using a JavaScript Engine;
the model execution engine providing the calculated information to the user interface in at least one screenshot on the user display, the displayed information including (i) the calculated bank pre-provision net revenue information, (ii) the calculated credit information, (iii) the calculated tax information, (iv) the calculated credit risk-weighted asset information, and (v) the calculated capital ratios;
the model wizard receiving updated user inputs from the user interface, the updated user inputs including at least one of: (i) updated input financial information comprising at least one of updated historical financial data, updated spot financial data, updated projected financial data, updated market financial data, and updated time data; (ii) updated risk information, and (iii) updated model equation information;
the model execution engine using the updated user inputs, data from the external data source, and data from the internal database, to execute at least one equation to calculate at least one of (i) updated bank pre-provision net revenue information, (ii) updated credit information, (iii) updated tax information, (iv) updated credit risk-weighted asset information, and (v) updated capital ratios;
the model execution engine providing the updated calculated information to the user interface in at least one screenshot on the user display, the displayed information including at least one of (i) the calculated updated bank pre-provision net revenue information, (ii) the calculated updated credit information, (iii) the calculated updated tax information, (iv) the calculated updated credit risk-weighted asset information, and (v) the calculated updated capital ratios;
the model execution engine executing the sensitivity analysis tool to (i) provide to the user interface display at least one screenshot for input of at least one custom stress test macro-economic driver-based scenario using at least one mathematical model stored in the internal database, and (ii) run the at least one scenario to determine model sensitivity and impact on the calculated updated capital ratios.

2. The apparatus according to claim 1, wherein the R model includes a flag indicating it is in the R language.

3. The apparatus according to claim 1, wherein the at least one stress-test server causes the updated calculated information to be supplied to the user display within 3 minutes of receiving the updated user inputs.

4. The apparatus according to claim 1, wherein the at least one stress-test server causes the updated calculated information to be supplied to the user display within 1 minute of receiving the updated user inputs.

5. The apparatus according to claim 1, wherein the model wizard includes a create/edit model module, a validate module, a submit model module, and an approve model module.

6. The apparatus according to claim 5, wherein the model execution engine includes a model repository module, a model input module, an execution module, a model output module, and a view and adjust model module.

7. The apparatus according to claim 6, wherein the create/edit model module includes a check user entitlement module, a forecaster module, an add/edit model metadata module, an add/edit model input attributes module, an add/edit risk attributes module, an add/edit model equation module, and a save draft module.

8. The apparatus according to claim 7, wherein the validate module and the submit model module include an open draft model module, an add model input data module, a validate model module, an expected output module, and a submit for approval module.

9. The apparatus according to claim 1, wherein the at least one server processor further executes core services comprising at least one equation application programming interface and at least one caching service.

10. The apparatus according to claim 1, wherein the at least one server processor integrates with SAP software.
